(19) United States
(12) Patent Application Publication
(10) Pub. No.: US 2013/0163283 A1
(43) Pub. Date: Jun. 27, 2013

(54) LIGHT GUIDE, LIGHT SOURCE UNIT, ILLUMINATING DEVICE, AND DISPLAY DEVICE

(71) Applicants: Atsuyuki Tanaka, Osaka-shi (JP); Takeshi Masuda, Osaka-shi (JP)

(72) Inventors: Atsuyuki Tanaka, Osaka-shi (JP); Takeshi Masuda, Osaka-shi (JP)

(73) Assignee: Sharp Kabushiki Kaisha, Osaka-shi, Osaka (JP)

(21) Appl. No.: 13/811,443

(22) PCT Filed: Apr. 7, 2011
(86) PCT No.: PCT/JP2011/058768

§ 371 Date: Jan. 22, 2013

(30) Foreign Application Priority Data
Jul. 23, 2010 (JP) 2010-166132

(51) Int. Cl. F21V 8/00

(52) U.S. Cl. CPC G02B 6/0001
USPC 362/611; 362/623

(57) ABSTRACT

A light guide (20) has a light receiving portion (21) for receiving light and a wall portion (22) contiguous therewith. The light receiving portion (21) has a light receiving surface on its floor surface (23) side, and includes a reflective surface (21a) in the shape of a curved surface for reflecting light toward the wall portion (22). The wall portion (22) includes a side wall (22S) having a coarse surface (25) for changing the light path of the light inside to one suitable for outward emission.

### TECHNICAL FIELD

The present invention relates to a light guide for guiding received light, a light source unit incorporating a light guide and a light source, an illuminating device incorporating a light source unit, and a display device incorporating an illuminating device.

### BACKGROUND ART

A liquid crystal display device (display device) that incorporates a non-luminous liquid crystal display panel (display panel) generally also incorporates a backlight unit (illuminating device) for supplying the liquid crystal display panel with light. Preferably, the backlight unit is so configured as to produce planar light that is distributed evenly over the entire area of the liquid crystal display panel, which is planar.

Backlight units for supplying a liquid crystal display panel with light roughly divide into a direct-lit type and an edge-lit type.

Direct-lit backlight units have a structure in which a plurality of LEDs (light emitting diodes) as a light source are arranged under a diffuser plate so that the light from the plurality of LEDs is diffused by the diffuser plate and is then discharged outside. With such a direct-lit backlight unit, by controlling the plurality of LEDs individually, it is possible to realize so-called area-by-area lighting control (local diming control, area-active control, etc.) whereby brightness in different areas of the backlight is adjusted in a fashion coordinated with brightness in different areas of the displayed image. This makes it possible to greatly improve the contrast of, and reduce the electric power consumption of, liquid crystal display devices.

In a direct-lit backlight unit, however, to suppress luminance unevenness in the light source section, the distance between the LEDs and the diffuser plate needs to be long enough. Inconveniently, this makes slimming-down difficult. In particular, in a case where the number of LEDs is reduced for cost reduction, the wider intervals between the LEDs make uneven luminance more likely. In this case, the distance between the LEDs and the diffuser plate needs to be longer, and this makes slimming-down more difficult. Thus, conventional direct-lit backlight units suffer from the difficulty achieving low cost and slimness simultaneously.

On the other hand, edge-lit backlight units have a structure in which a light source such as LEDs is arranged at a side surface of a light guide plate so that the light emitted from the light source is introduced into the light guide plate through the side surface and the introduced light is then guided inside the light guide plate to be discharged toward a liquid crystal display panel. With such an edge-lit backlight unit, the light from the LEDs can be discharged upward with a moderate thickness of the light guide plate, and this makes the slimming-down of liquid crystal display devices easy.

Also conventionally proposed are edge-lit backlight units that employ a bar-shaped light guide (light guide bars) instead of a light guide plate (see, for example, Patent Document 1 listed below).

Patent Document 1 discloses an edge-lit backlight unit that is provided with a plurality of light guide bars and a plurality of LEDs that shine light into the light guide bars through their end surfaces. In this backlight unit, the light guide bars are arranged in rows in a manner corresponding to the LEDs, and the plurality of light guide bars multiply reflect the light introduced into them through their end surfaces, thereby to guide the light to their ceiling surfaces and then discharge it outside.

### LIST OF CITATIONS

### Patent Literature

Patent Document 1: Japanese Patent Application Publication No. 2007-227074 (see FIG. 5)

### SUMMARY OF INVENTION

### Technical Problem

However, edge-lit backlight units, though more suitable for slimming down than the direct-lit type, has the disadvantage of a great loss in incident light on the end surface of a light guide plate or light guide bars, resulting in low light use efficiency.

Edge-lit backlight units employing a light guide plate can simply emit light from over the entire image area, and has the disadvantage of not allowing area-by-area lighting control such as local dimming control.

The backlight unit disclosed in Patent Document 1, if so configured that the lighting of LEDs can be controlled individually, allows line scanning whereby one illuminating region after another is scanned in a line-sequential fashion, but has the disadvantage of not allowing area-by-area lighting control such as local dimming control (local control of light amount).

The present invention has been devised to overcome the inconveniences and disadvantages discussed above, and has, as one object, to provide a light guide, a light source unit, an illuminating device, and a display device that help achieve cost reduction along with high efficiency and slimness.

The present invention has, as another object, to provide an illuminating device that allows local control of light amount and offers high-quality planar light, and to provide a display device incorporating such an illuminating device.

### Solution to Problem

To achieve the above objects, according to a first aspect of the present invention, a light guide for guiding received light inside is provided with: a light receiving portion for receiving light; and a wall portion contiguous with the light receiving portion. The light receiving portion has a light receiving surface at the floor surface side thereof and includes a reflective surface in the shape of a curved surface for reflecting light toward the wall portion. The wall portion includes a side wall having a light path changing processed surface for changing the light path of the light inside to a light path suitable for outward emission.

With this light guide according to the first aspect, as described above, owing to the provision of the light receiving portion including a reflective surface in the shape of a curved surface, the light introduced into the light receiving portion from its floor surface side is reflected on the reflective surface so that the introduced light (the received light) can be guided toward the wall portion. Moreover, owing to the provision of the light path changing processed surface on the side surface of the wall portion, the light path of the light inside the light guide can be changed to one suitable for outward emission. Thus, the light inside the light guide that is guided toward the wall portion can be emitted outside through the side wall of the wall portion. That is, a large amount of light can easily be emitted outside through the side wall of the wall portion.

Accordingly, by building a direct-lit illuminating device by use of such a light guide, for example, even with a reduced number of light sources, it is possible to obtain high-quality planar light with suppressed luminance unevenness. In addition, the planar light is produced not mainly from the light from the ceiling surface (ceiling wall) of the wall portion but from the light from the side wall of the wall portion. Thus, for example, even with a shortened distance from the light source to the diffuser plate, it is possible to suppress luminance unevenness. It is possible to reduce cost and simultaneously make the illuminating device slim. Thus, the light guide can be suitably used in an illuminating device that is required to supply high-quality planar light.

According to the first aspect, owing to the reflective surface of the light receiving portion being formed in the shape of a curved surface, the light introduced into the light receiving portion can easily be totally reflected on the reflective surface. This makes leakage of light from the light receiving portion less likely, and thus it is possible to suppress appearance of a bright spot resulting from leakage of light.

According to the first aspect, owing to the use of the light guide described above, as compared with a case where a light guide plate in the form of a single plate is used, it is possible to reduce material cost. This too helps achieve cost reduction.

According to the first aspect, by building a direct-lit illuminating device by use of the light guide described above, as compared with an edge-lit illuminating device, it is possible to reduce loss in incident light, and thus it is possible to obtain a high-efficiency illuminating device.

In the light guide according to the first aspect described above, preferably, the light receiving portion has a shape using part of a spheroid. With this structure, the light introduced into the light receiving portion can be totally reflected effectively, and thus it is possible to suppress leakage of light effectively.

In this case, it is preferable that the rotation axis of the spheroid be inclined with respect to the ceiling wall of the wall portion. By forming the reflective surface of the light receiving portion by use of part of the surface of a spheroid with inclined rotation axis in this way, the light introduced into the light receiving portion can be totally reflected more effectively, and thus it is possible to suppress leakage of light more effectively.

In the structure described above where the light receiving portion has a shape using part of a spheroid, preferably, the light receiving portion has the shape of a plurality of spheroids coupled together, and one focal point of each of the plurality of spheroids coincides with one focal point of every other of the plurality of spheroids. With this structure, for example, when the light receiving point of the light receiving portion overlaps the one focal point included in the parts of the plurality of spheroids where these overlap each other, light is more likely to pass by the other focal point of the spheroids. Thus, with this structure, it is easier to reflect light toward the wall portion efficiently.

In this case, it is preferable that the light receiving portion have the shape of two spheroids coupled together, and that one focal point of one of the spheroids coincide with one focal point of the other of the spheroids.

In the light guide according to the first aspect described above, preferably, a deflecting processed surface for deflecting light upward is formed on the floor surface of the wall portion, and a lens for diffusing the light is formed on the ceiling wall of the wall portion. With this structure, for example, of the light that has entered the wall portion, the part that reaches the floor wall is so guided as to be deflected upward by the deflecting processed surface, and this makes the light more likely to travel toward the ceiling wall. The light thus deflected upward can then be emitted outside while being diffused by the lens located on the ceiling wall of the wall portion.

In the light guide according to the first aspect described above, the wall portion may be fainted in the shape of a bar. In this case, it is preferable that the light receiving portion of the light guide be formed at an end of the wall portion formed in the shape of a bar.

In this case, it is further preferable that the light receiving portion be disposed between two of the wall portions each formed in the shape of a bar, and that the received light be guided in two directions by the reflective surface in the light receiving portion.

In the structure described above where the wall portion is formed in the shape of a bar, preferably, a retroreflective structure for reflecting the incident light in a direction from which the light is incident is formed in a tip-end part of the wall portion. With this structure, emission of light from the tip-end part of the wall portion is suppressed, and thus it is possible to suppress appearance of a bright spot resulting from light being emitted from the tip-end part of the wall portion. Thus, it is possible to obtain higher-quality planar light.

In this case, preferably, the retroreflective structure includes a projection having the shape of a quadrangular pyramid. With this structure, it is possible to easily suppress emission of light from the tip-end part of the wall portion.

In the structure described above where the wall portion is formed in the shape of a bar, it is preferable that the wall portion in the shape of a bar have a shape that tapers off the farther away from the light receiving portion. By giving the bar-shaped wall portion a tapered shape in this way, it is possible to suppress leakage of light from the tip-end part of the wall portion.

In the light guide according to the first aspect described above, it is preferable that the light path changing processed surface include a prismed surface, a crimped surface, or a dot-printed surface. By forming such a processed surface on the side wall in this way, it is possible to easily change the optical path of the light inside the light guide to one suitable for outward emission.

In the light guide according to the first aspect described above, preferably, the light receiving portion has a recess caved in from the floor surface thereof, and the recess is the part of the light receiving portion where it receives light. With this structure, it is easy to align the light source.

According to a second aspect of the present invention, a light source unit is provided with: a light guide according to the first aspect described above; and a light source for supplying the light guide with light. With this structure, it is possible to obtain a low-cost, high-efficiency light source unit that is suitable to build a slim illuminating device.

In the light source unit according to the second aspect described above, preferably, the wall portion of the light guide is formed in the shape of a bar, and a plurality of the light guides are arrayed with each of them slanted and are put together end-on-end. With this structure, between adjacent light guides, it is possible to suppress light traveling from one light guide to the other. Thus, it is possible to suppress illuminance unevenness resulting from light traveling from one light guide to the other. It is thus possible to obtain high-quality planar light.

In this case, by providing a projection having the shape of a quadrangular pyramid in a tip-end part of the wall portion, it is possible, with the projection having the shape of a quadrangular pyramid, to alleviate leakage of light from the tip-end part of the wall portion. Thus, with this structure, it is possible to suppress illuminance unevenness more effectively.

In the light source unit according to the second aspect described above, it is preferable that the light source be a light emitting device, and that the light receiving portion of the light guide be arranged over the light emitting device.

According to a third aspect of the present invention, an illuminating device is provided with a light source unit according to the second aspect described above. With this structure, it is possible to easily obtain a low-cost, high-efficiency, slim illuminating device. In addition, it is possible to obtain high-quality planar light.

According to the third aspect, owing to the provision of the light source unit according to the second aspect described above, it is possible to build a direct-lit illuminating device. By controlling the lighting of light sources in the light source unit individually, it is possible to achieve area-by-area lighting control (local control of light amount) such as local dimming control.

In the illuminating device according to the third aspect described above, preferably, there is further provided a fixing member for fixing the light guide, and the fixing member covers at least part of the light receiving portion. With this structure, even light leaks from the light receiving portion, the leaking light can be shielded by the fixing member. Thus, it is possible to suppress illuminance unevenness more effectively.

In this case, preferably, the fixing member is formed of a white resin. With this structure, since a white resin has high reflectance, when light leaks from the light receiving portion, the leaking light is reflected on the fixing member so as to be easily guided to the wall portion of the light guide.

In the illuminating device according to the third aspect described above, preferably, there is further provided a diffuser plate for diffusing the light from the light guide, and the diffuser plate is arranged over the light source and the light guide. With this structure, it is possible to easily obtain a low-cost, slim direct-lit light emitting device.

According to a fourth aspect of the present invention, a display device is provided with: an illuminating device according to the third aspect described above; and a display panel receiving light from the illuminating device. With this structure, it is possible to easily obtain a low-cost, slim display device that can perform area-by-area lighting control (local control of light amount) such as local dimming control.

### Advantageous Effects of the Invention

As described above, according to the present invention, it is possible to easily obtain a light guide, a light source unit, an illuminating device, and a display device that help achieve cost reduction along with high efficiency and slimness.

According to the present invention, it is also possible to easily obtain an illuminating device that allows local control of light amount and offers high-quality planar light, and a display device incorporating such an illuminating device.

### BRIEF DESCRIPTION OF DRAWINGS

FIG. 1 is a perspective view of a light guide according to a first embodiment of the invention;

FIG. 2 is a perspective view of a light source unit employing the light guide according to the first embodiment of the invention;

FIG. 3 is an exploded perspective view of a liquid crystal display device incorporating a backlight unit according to the first embodiment of the invention;

FIG. 4 is a side view of the light guide according to the first embodiment of the invention;

FIG. 5 is a plan view of the light guide according to the first embodiment of the invention;

FIG. 6 is a sectional view along line A-A in FIG. 5;

FIG. 7 is a diagram in illustration of the shape of the light receiving portion of the light guide according to the first embodiment of the invention (a view as seen from direction A1 in FIG. 5);

FIG. 8 is a plan view in illustration of the shape of the light receiving portion of the light guide according to the first embodiment of the invention;

FIG. 9 is a sectional view of the light source unit according to the first embodiment of the invention, and also is a light path diagram showing the path of light;

FIG. 10 is a plan view of the light source unit according to the first embodiment of the invention, and also is a light path diagram showing the path of light;

FIG. 11 is a plan view of the light source unit according to the first embodiment of the invention;

FIG. 12 is a perspective view of a light guide unit having light guides according to the first embodiment of the invention put together end-on-end;

FIG. 13 is a plan view of the light guide unit having light guides according to the first embodiment of the invention put together end-on-end;

FIG. 14 is a plan view of a backlight unit employing the light guide (light source unit) according to the first embodiment of the invention;

FIG. 15 is a perspective view showing a light guide according to a second embodiment of the invention;

FIG. 16 is a plan view showing the light guide according to the second embodiment of the invention;

FIG. 17 is a side view showing the light guide according to the second embodiment of the invention;

FIG. 18 is a perspective view showing a light guide unit having light guides according to the second embodiment of the invention put together end-on-end;

FIG. 19 is a plan view showing a light guide unit having light guides according to the second embodiment of the invention put together end-on-end;

FIG. 20 is a plan view of a light source unit employing the light guide according to the second embodiment of the invention;

FIG. 21 is a plan view showing a light source unit according to a third embodiment of the invention;

FIG. 22 is a plan view showing a light source unit according to the third embodiment of the invention (showing another example);

FIG. 23 is a plan view showing a light source unit according to a modified example of the third embodiment;

FIG. 24 is a plan view showing a light source unit according to the modified example of the third embodiment (showing another example);

FIG. 25 is a plan view showing an example in which the light source unit according to the modified example of the third embodiment is provided with a retroreflective structure;

FIG. 26 is a plan view showing the example in which the light source unit according to the modified example of the third embodiment is provided with a retroreflective structure (a partly magnified view), and also is a light path diagram showing the path of light;

FIG. 27 is a perspective view of a light source unit employing a light guide according to a fourth embodiment of the invention;

FIG. 28 is a sectional view of the light source unit employing the light guide according to the fourth embodiment of the invention, and also is a light path diagram showing the path of light;

FIG. 29 is a plan view of the light source unit employing the light guide according to the fourth embodiment of the invention;

FIG. 30 is a perspective view in illustration of a backlight unit according to a fifth embodiment of the invention;

FIG. 31 is a plan view in illustration of the backlight unit according to the fifth embodiment of the invention;

FIG. 32 is a perspective view showing a fixing member used in the backlight unit according to the fifth embodiment of the invention;

FIG. 33 is a sectional view (a view corresponding to the section along line B-B in FIG. 31) showing the light guide fixed by the fixing member in the backlight unit according to the fifth embodiment of the invention;

FIG. 34 is a side view showing the light guide fixed by the fixing member in the backlight unit according to the fifth embodiment of the invention;

FIG. 35 is a perspective view of a light source unit employing a light guide according to a sixth embodiment of the invention;

FIG. 36 is a side view of the light source unit employing the light guide according to a sixth embodiment of the invention;

FIG. 37 is a sectional view of the light source unit employing the light guide according to a sixth embodiment of the invention, and also is a light path diagram showing the path of light;

FIG. 38 is a perspective view showing a light guide according to a seventh embodiment of the invention;

FIG. 39 is a plan view showing the light guide according to the seventh embodiment of the invention;

FIG. 40 is a plan view of a light guide unit having light guides put together end-on-end according to the seventh embodiment of the invention;

FIG. 41 is a plan view of a light guide unit having light guides put together end-on-end according to the seventh embodiment of the invention;

FIG. 42 is a plan view showing a light guide according to an eighth embodiment of the invention;

FIG. 43 is a perspective view showing the light guide according to the eighth embodiment of the invention;

FIG. 44 is a sectional view of a light source unit employing a light guide according to a first modified example, and is also a light path diagram showing the path of light;

FIG. 45 is a sectional view of a light source unit employing a light guide according to a second modified example, and is also a light path diagram showing the path of light;

FIG. 46 is a sectional view showing part of FIG. 45 on a magnified scale;

FIG. 47 is a sectional view of a light source unit employing a light guide according to a third modified example, and is also a light path diagram showing the path of light; and

FIG. 48 is a sectional view showing part of FIG. 47 on a magnified scale.

### DESCRIPTION OF EMBODIMENTS

Hereinafter, embodiments of the present invention will be described in detail with reference to the accompanying drawings.

### Embodiment 1

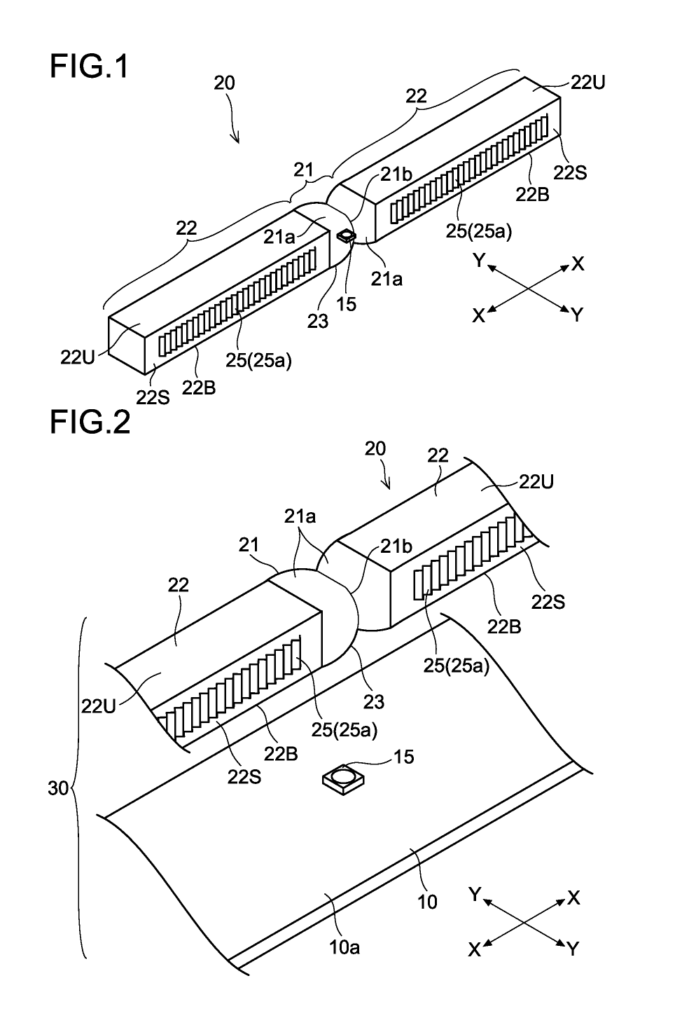

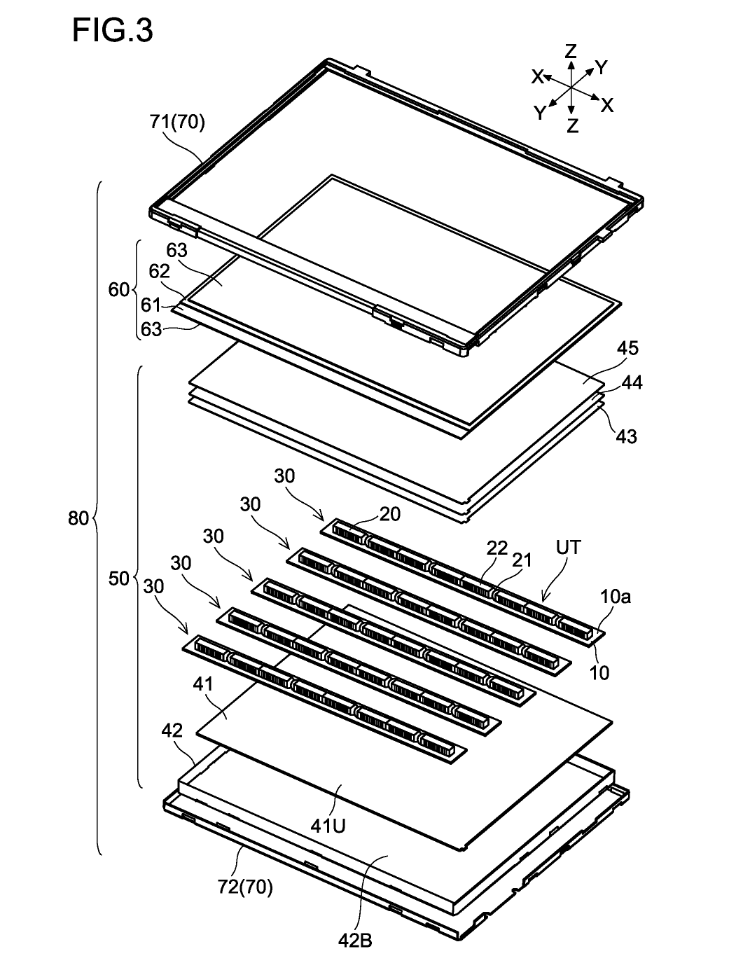

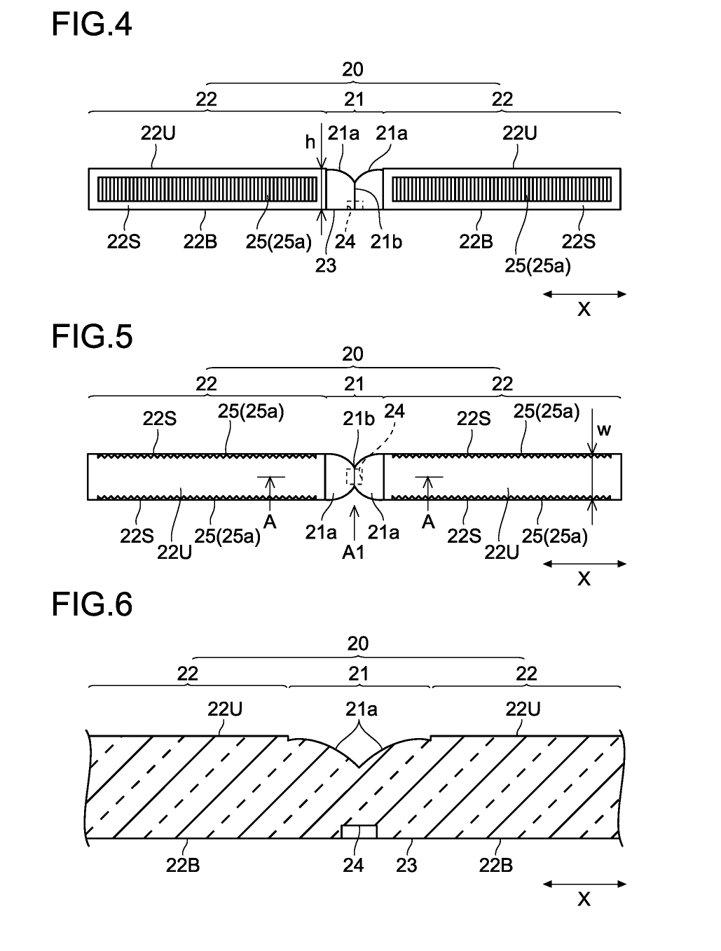

FIG. 1 is a perspective view of a light guide according to a first embodiment of the invention. FIG. 2 is a perspective view of a light source unit employing the light guide according to the first embodiment of the invention. FIG. 3 is an exploded perspective view of a liquid crystal display device incorporating a backlight unit according to the first embodiment of the invention. FIGS. 4 to 14 are diagrams in illustration of the light guide etc. according to the first embodiment of the invention. First, with reference to FIGS. 1 to 14, the light guide, the light source unit, the backlight unit, and the liquid crystal display device according to the first embodiment of the invention will be described.

As shown in FIG. 3, the liquid crystal display device 80 according to the first embodiment is provided with a liquid crystal display panel 60, a backlight unit 50 which supplies the liquid crystal display panel 60 with light, and a housing 70 composed of a pair of housing members (a front housing member 71 and a rear housing member 72) disposed opposite each other with the liquid crystal display panel 60 and the backlight unit 50 in between. The liquid crystal display device 80 is an example of a “display device” according to the invention, and the liquid crystal display panel 60 is an example of a “display panel” according to the invention. The backlight unit 50 is an example of an “illuminating device” according to the invention.

The liquid crystal display panel 60 is composed of an active matrix substrate 61, which includes switching devices such as TFTs (thin-film transistors), and a counter substrate 62, which is disposed opposite the active matrix substrate 61, bonded together with a sealing member (not shown). The gap between the two substrates 61 and 62 is filled with liquid crystal (not shown). The active matrix substrate 61 is, on its light receiving surface, laid with a polarizer film 63, and the counter substrate 62 is, on its light emitting surface, laid with another polarizer film 63.

Structured as described above, the liquid crystal display panel 60 displays an image by exploiting variation in transmittance resulting from inclination of liquid crystal molecules.

The backlight unit 50 according to the first embodiment is built as a direct-lit type, and includes a plurality of light source units 30, a reflective sheet 41, a backlight chassis 42, a diffuser plate 43, a prism sheet 44, and a lens sheet 45. The backlight unit 50 is arranged immediately behind the liquid crystal display panel 60.

As shown in FIGS. 1 and 2, the light source unit 30 provided in the backlight unit 50 includes a mounting board 10, an LED (light emitting device, point light source) 15 as a light source which is mounted on the mounting board 10, and a light guide 20 which is provided on the mounting board 10.

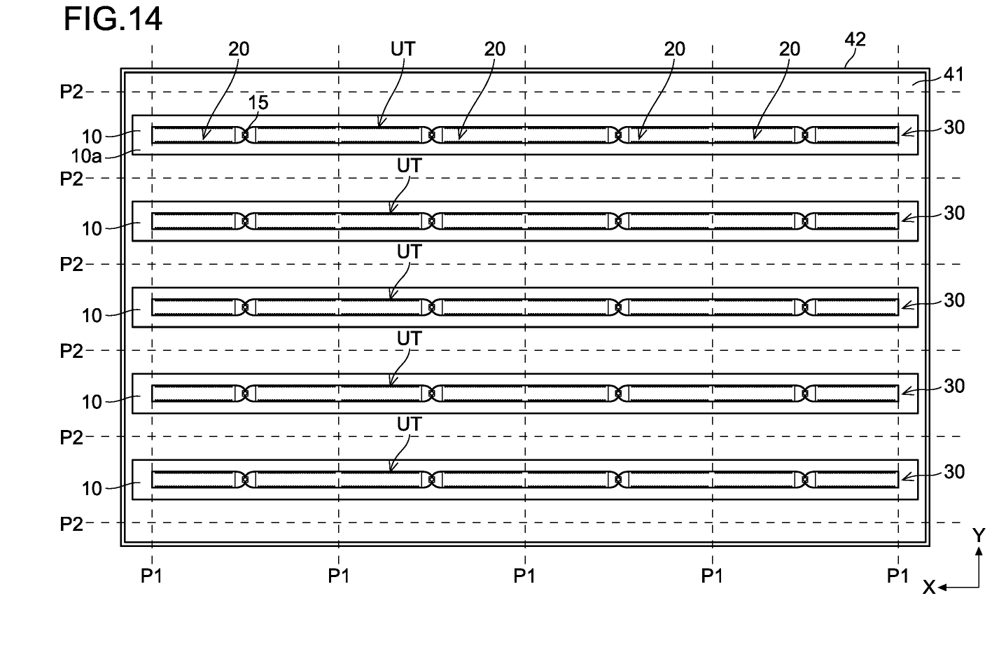

As shown in FIGS. 3 and 14, the mounting board 10 is a rectangular, plate-shaped board, and has a plurality of electrodes (not shown) arrayed on its mounting surface 10a. The mounting board 10 is formed so as to extend in the X direction, and a plurality of like mounting boards 10 are arrayed in the direction (Y direction) crossing the X direction. The electrodes formed on the mounting board 10 are terminals for supplying electric power to a light source (light emitting device) like the LED 15.

The mounting surface 10a of the mounting board 10 may be coated with a resist film (not shown) as a protective film. It is preferable, but not essential, that the resist film be white so as to be reflective. When a white resist film is formed as the resist film on the mounting boards 10 in this way, even if light is incident on the resist film, the light is reflected on the resist film and is thereby deflected outside. This helps eliminate the cause of uneven light distribution resulting from absorption of light by the mounting boards 10.

The LED 15 is mounted on the electrodes formed on the mounting board 10 and, by receiving electric current via them, emits light. To secure a sufficient amount of light, it is preferable that a plurality of LEDs 15 be mounted on the mounting board 10. In the drawings, however, for convenience' sake, only part of such LEDs 15 are shown. The plurality of LEDs 15 mounted on the mounting board 10 are so configured that their lighting can be controlled individually.

As shown in FIGS. 1 and 2, the light guide 20 includes a light receiving portion 21 which receives light from the LED 15 and a wall portion 22 which is contiguous with the light receiving portion 21. The light guide 20 is formed of a transparent resin material, such as acrylic resin or polycarbonate, that internally reflects light and thereby lets it travel forward. The light receiving portion 21 and the wall portion 22 are formed integrally out of that material.

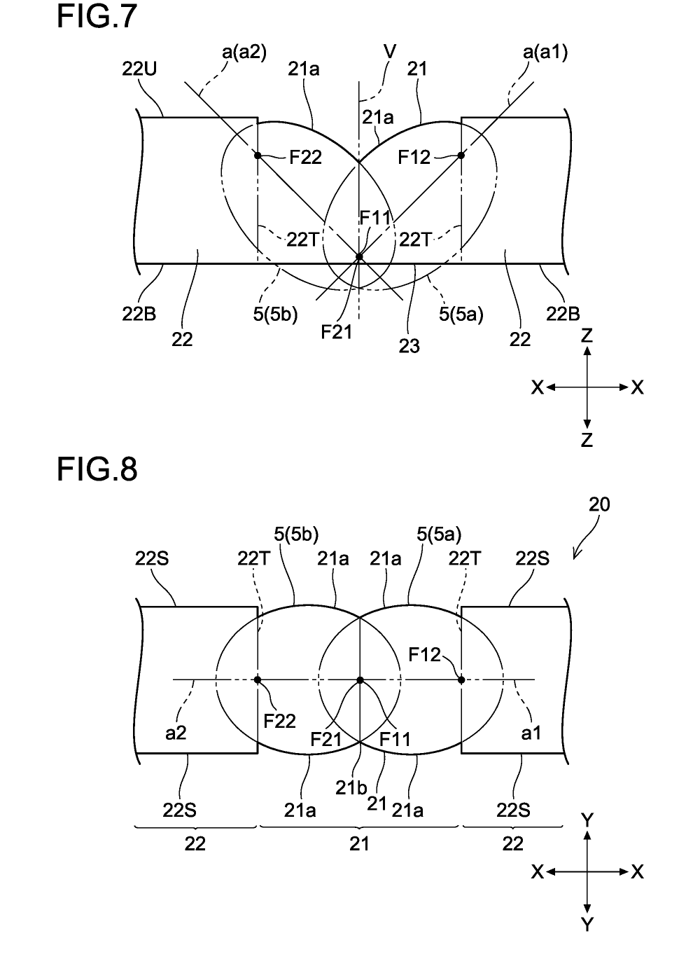

As shown in FIGS. 4 to 6, the light receiving portion 21 of the light guide 20 has a curved surface. As shown in FIGS. 7 and 8, the shape of this curved surface is formed by use of part of a spheroid (ellipsoid of revolution) 5 obtained by revolving an ellipse. Thus, the surface of the light receiving portion 21 has a shape similar to that of the surface of the spheroid 5. That is, the light receiving portion 21 has a shape using part of the spheroid 5. The surface (curved surface) of the light receiving portion 21 thus formed by part of the spheroid 5 serves as a reflective surface 21a which reflects light introduced into the light receiving portion 21.

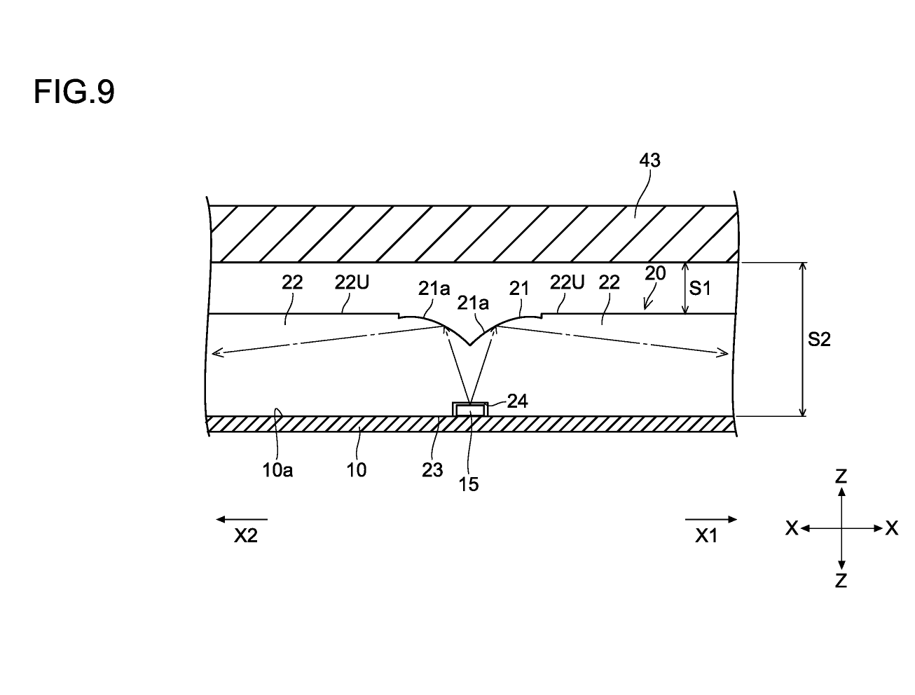

As shown in FIG. 9, the light receiving portion 21 of the light guide 20 is so structured that light is introduced into it from the floor surface 23 side. That is, the light receiving surface is provided on the floor surface 23 side of the light guide 20. The light guide 20 is so structured that the light introduced into it from the floor surface 23 side of the light receiving portion 21 is reflected on the reflective surface 21a so as to be guided toward the wall portion 22.

As shown in FIGS. 4, 5, and 11, the wall portion 22 of the light guide 20 is formed in the shape of a bar extending in one direction (X direction). Specifically, the wall portion 22 is formed, for example, in the shape of a rectangular prism. In that case, the wall portion 22 are given a width w (see FIG. 5) of, for example, about 3 mm to about 6 mm and a height h (see FIG. 4) of about 4 mm to about 6 mm.

At one end of the wall portion 22, the light receiving portion 21 is provided, and these are so structured that the light introduced into the light receiving portion 21 is guided through that end of the wall portion 22 into the wall portion 22. The side wall 22S of the wall portion 22 has a coarse surface (refractive index changing surface) 25 which changes the angle of refraction of the light traveling forward. One example of the coarse surface 25 is, as shown in FIGS. 1 and 2, a prismed surface 25a having triangular prisms arrayed in the X direction on the side wall 22S. The coarse surface 25 is so configured that it can receive light at angles smaller than the critical angle of the light guide 20. The coarse surface 25 is one example of a “light path changing processed surface” according to the invention. In the first embodiment under discussion, an example is taken where the prismed surface 25a is provided in a substantially central part of the wall portion 22 in its thickness direction.

Here, in the first embodiment, as shown in FIGS. 7 and 8, the light receiving portion 21 has a structure in which two spheroids 5 (5a and 5h) are coupled together. The two spheroids 5 are coupled together with their respective rotation axes a (a1 and a2) crossing each other and with their respective tip-end parts overlapping each other. Here, when the light guide 20 is viewed from the side (from direction A1 in FIG. 5), as shown in FIG. 7, the spheroids 5 have their rotation axes a (a1 and a2) inclined with respect to the extension direction (X direction) of the wall portion 22. As shown in FIG. 8, when the light guide 20 is seen in a plan view, the two spheroids 5 have their rotation axes a (a1 and a2) both aligned with the extension direction (X direction) of the wall portion 22.

In the first embodiment, the two spheroids 5 are so configured that a focal point F11 (one focal point F11) of one spheroid 5a coincides with a focal point F21 (one focal point F21) of the other spheroid 5b. When the other focal point corresponding to the focal point F11 is referred to as the focal point F12 and the other focal point corresponding to the focal point F21 is referred to as the focal point F22, the spheroids 5 have their respective other focal points F12 and F22 located closer to the ceiling surface of the light guide 20 (the ceiling wall 22U of the wall portion 22) than are their coincident focal points F11 and F21.

The two spheroids 5 are also so configured as to be symmetric about the vertical line V in FIG. 7 (the line V passing through the coincident focal points F11 and F21 (the intersection between the rotation axes a1 and a2) and perpendicular to the extension direction (X direction) of the wall portion 22). The light receiving portion 21 structured as described has a constriction line 21b formed where the two spheroids 5 are coupled together.

Moreover, the light guide 20 is so structured that the light receiving portion 21 is located between two wall portions 22. Specifically, one of the two spheroids 5 constituting the light receiving portion 21 is fitted to an end of one of the two wall portions 22 between which the light receiving portion 21 is located, and the other of the two spheroids 5 is fitted to an end of the other of the two wall portions 22.

In the first embodiment, the spheroids 5 are so structured that, as seen in a plan view, their respective other focal points F12 and F22 coincide with ends (end surfaces 22T) of the wall portions 22. The spheroids 5 do not necessarily have to have their other focal points F12 and F22 coincident with the ends (end surfaces 22T) of the wall portions 22; it is, however, preferable that these focal points F12 and F22 be either coincident with or located on the wall portion 22 side of the ends (end surfaces 22T) of the wall portions 22.

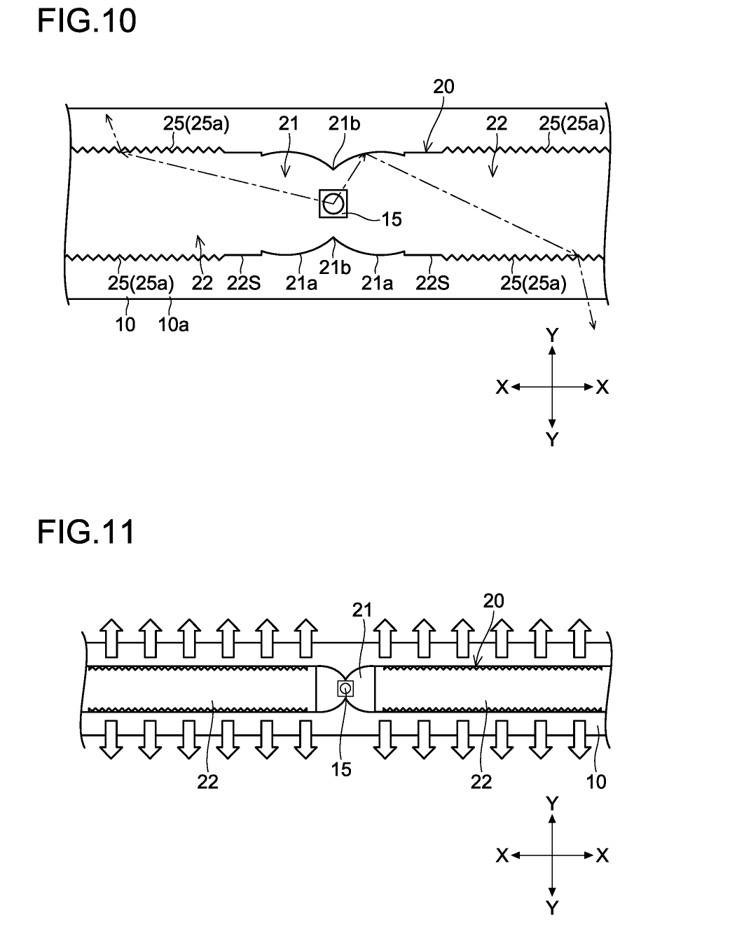

As shown in FIGS. 6 and 9, in the light receiving portion 21 of the light guide 20, a recess 24 is formed which is caved in from the floor surface 23. The recess 24 is formed in a position that, as seen in a plan view, overlaps the coincident focal points F11 and F21 (see FIG. 8) of the two spheroids 5. As shown in FIG. 9, in the recess 24, an LED 15 as a light source 15 is accommodated. When the LED 15 housed there is seen in a plan view, as shown in FIG. 10, the light guide 20 is so fitted that the light emission point of the LED 15 overlaps the focal point F11 (F21) of the spheroid 5. Thus, the light receiving point, that is, the point at which the light from the LED 15 is received first, overlaps the focal point F11 (F21) of the spheroid 5.

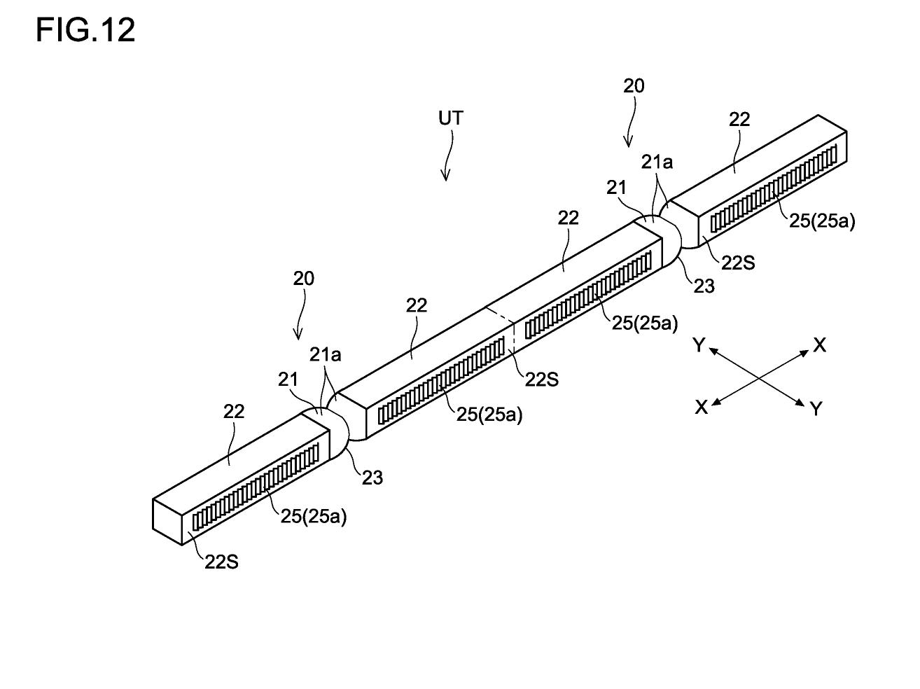

As shown in FIGS. 12 to 14, a plurality of light guides 20 as described above are arrayed in one direction and are put together end-on-end to form a light guide unit UT. Specifically, in the first embodiment, a plurality of light guides 20 are coupled together in such a way that ends of adjacent wall portions 22 face each other. The light guide unit UT may be composed of a plurality of light guides 20 coupled integrally together, or may be composed of a plurality of light guides 20 arrayed discretely. As shown in FIGS. 3 and 14, a plurality of light guide units UT as described above are arranged side by side. Hence, a plurality of light source units 30 are arranged side by side.

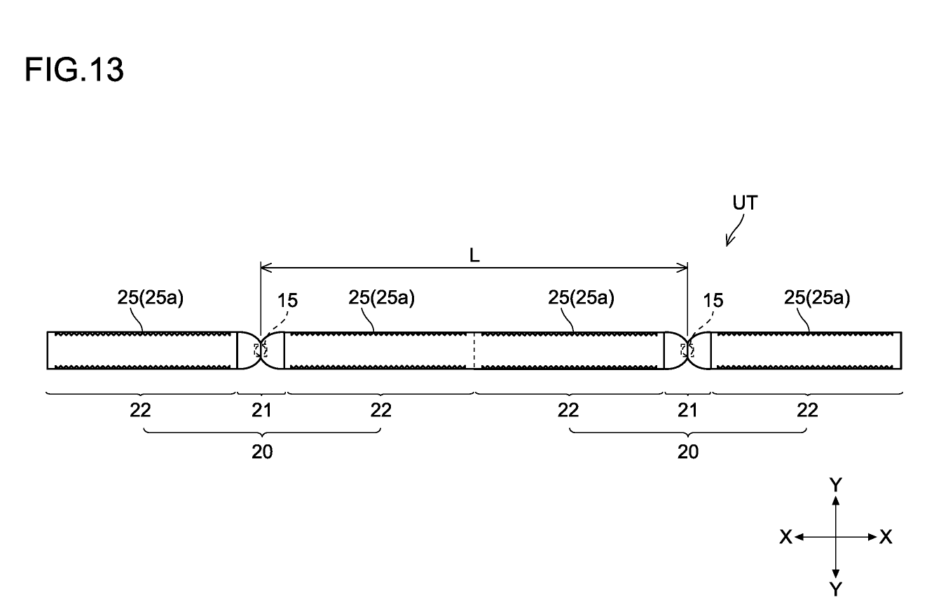

The light guides 20 (the light guide unit UT) structured as described above are fitted on a mounting board 10 having LEDs 15 mounted on it, in such a way that the LEDs 15 are covered by the light receiving portions 21 (with the LEDs 15 located inside the recesses 24), to form a light source unit 30. In the first embodiment, as shown in FIG. 13, the interval L between the LEDs 15 in the light source unit 30 (light guide unit UT) is, for example, about 54.5 mm.

As shown in FIG. 3, the reflective sheet 41 included in the backlight unit 50 is an optical member that is located immediately behind an array of mounting boards 10 (light source units 30) arranged side by side. The reflective sheet 41 has its reflective surface 41U facing the mounting boards 10 so that, of the light emitted from the light guide units UT, the part that travels not toward the diffuser plate 43 but toward the mounting boards 10 is reflected toward the diffuser plate 43.

The backlight chassis 42 is, for example, a box-shaped member, and accommodates the reflective sheet 41 and the light source units 30, with the reflective sheet 41 laid on the floor surface 42B and the light source units 30 arranged on top.

The diffuser plate 43 is an optical sheet that is laid over the light source units 30, and diffuses the light emitted from the light source units 30. That is, the diffuser plate 43 diffuses planar light formed through superposition of light from a plurality of light source units 30 so that light is distributed evenly over the entire area of the liquid crystal display panel 60. The diffuser plate 43 may be arranged on top of the light guides 20 (light guide units UT) in direct contact with them, but it is preferable to arrange it, as shown in FIG. 9, a predetermined distance S1 (for example, about 4 mm to about 6 mm) away from the ceiling surface of the light guide 20 (the ceiling wall 22U of the wall portion 22). Leaving a spatial distance above the light guides 20 in this way makes it easy to suppress luminance unevenness. In the first embodiment, the distance S2 from the mounting surface 10a of the mounting boards 10 to the diffuser plate 43 is set to be about 10 mm.

As shown in FIG. 3, the prism sheet 44 is an optical sheet that is laid over the diffuser plate 43. The prism sheet 44 has, for example, triangular prisms extending in one direction (linearly) arranged side by side in a direction crossing that one direction across the sheet surface. The prism sheet 44 changes the propagation characteristics of the light from the diffuser plate 43.

The lens sheet 45 is an optical sheet that is laid over the prism sheet 44. The lens sheet 45 has dispersed in it fine particles that scatter light by refraction. The prism sheet 44 prevents the light from the prism sheet 44 from condensing locally, and thereby suppresses brightness difference (uneven light distribution).

In the backlight unit 50 according to the first embodiment structured as described above, the light from the plurality of light source units 30 are superposed into planar light, which is then supplied through a plurality of sheets of optical members 43 to 45 to the liquid crystal display panel 60. Receiving the light (backlight) from the backlight unit 50, the liquid crystal display panel 60 of a non-luminous type offers improved display performance.

Since the backlight unit 50 according to the first embodiment is built as a direct-lit type, the light source units 30 are located immediately behind the diffuser plate 43. In other words, the light source units 30 (LEDs 15) are arranged in an area that corresponds to the display area of the liquid crystal display panel 60.

Next, with reference to FIGS. 7, 9 to 11, and 14, the workings of the backlight unit 50 (in particular, the light source unit 30) according to the first embodiment will be described.

As shown in FIG. 9, the light emitted upward from the LED 15 reaches the reflective surface 21a of the light receiving portion 21 as indicated by dash-and-dot-line arrows. The reflective surface 21a, by being formed into a curved surface formed by the surface of an ellipsoid, is so configured that light is incident on the reflective surface 21a at comparatively large angles of incidence. This make it easy for the reflective surface 21a of the light receiving portion 21 to totally reflect the light emitted from the LED 15. Accordingly, the light from the LED 15 that has reached the reflective surface 21a of the light receiving portion 21 is totally reflected on the reflective surface 21a to be guided toward the wall portion 22 (see the dash-and-dot-line arrows).

In the first embodiment, since the light receiving portion 21 of the light guide 20 has a structure in which two spheroid 5a (see FIG. 7) are coupled together, light that has reached the part corresponding to one spheroid is guided to a wall portion 22 at one side, and light that has reached the part corresponding to the other spheroid is guided to another wall portion 22 at the opposite side. That is, the light emitted from the LED 15 is guided in two directions (X1 and X2 directions) by the light receiving portion 21.

As shown in FIG. 7, owing to the structure where the focal point F11 of one spheroid 5a coincides with the focal point F21 of the other spheroid 5b, the light from the LED 15 is reflected on the reflective surface 21a of the light receiving portion 21 so as to be more likely to pass by the other focal point f12 (f22). Thus, the light emitted upward from the LED 15 is efficiently guided toward the wall portion 22.

As shown in FIG. 10, since the coarse surface 25 like the prismed surface 25a is formed on the side wall 22S of the wall portion 22, the optical path of the light traveling forward inside the wall portion 22 is changed by the coarse surface 25 to one suitable for outward emission. That is, the light inside the light guide 20 is more likely to be incident on the coarse surface 25 at angles smaller than the critical angle.

Thus, the light traveling forward inside the wall portion 22 is then more likely to travel outward in different directions via the coarse surface 25 on the side wall 22S. Consequently, the light introduced into the light guide 20 from the LED 15 is, as shown in FIG. 11, radiated sideways from the side wall 22S of the wall portion 22. In FIG. 11, hollow arrows indicate the light radiated.

As shown in FIG. 14, owing to a plurality of such light guides 20 (light guide units UT) being arranged in an array, the light from the light guides 20 are mixed to a high degree to produce wide-area, high-quality planar light.

Owing to the lighting of the LEDs 15 in the light source unit 30 being controlled individually, for example, lighting can be controlled (the amount of light can be controlled locally) for each of the areas surrounded by broken lines P1 and P2. Thus, by use of the backlight unit 50 structured as described above, it is possible to realize area-by-area lighting control (local dimming control, area-active control, etc.) whereby brightness in different areas of the backlight is adjusted in a fashion coordinated with brightness in different areas of the displayed image.

In the first embodiment, as described above, by use of the light guide 20 (light guide unit UT) including the light receiving portion 21 and the wall portion 22, the light emitted upward from the LED 15 is guided to the wall portion 22 by the light receiving portion 21 of the light guide 20, so that the light can be radiated sideways from the side wall 22S of the wall portion 22. That is, by use of the light guide 20 described above, the light radiated upward from the LED 15 can be spread sideways. Thus, even with a reduced number of LEDs 15 and hence a greater interval between them, high-quality planer light can be obtained with suppressed luminance unevenness. In addition, the planar light is produced not mainly from the light from the ceiling wall 22U of the wall portion 22 but from the light radiated sideways from the side wall 22S of the wall portion 22; thus, even with a reduced distance from the LED 15 to the diffuser plate 43, luminance unevenness can be suppressed. Consequently, by reducing the number of LEDs 15 mounted, it is possible to reduce cost and even then it is possible to suppress an increase in the thickness of the backlight unit 50. That is, it is possible to reduce cost and simultaneously make the backlight unit 50 (liquid crystal display device 80) slim.

In the first embodiment, owing to the reflective surface 21a of the light receiving portion 21 being formed into a curved surface, the light introduced into the light receiving portion 21 can easily be totally reflected on the reflective surface 21a. This makes leakage of light from the light receiving portion 21 less likely, and thus it is possible to suppress appearance of a bright spot resulting from leakage of light.

In the first embodiment, owing to the use of the light guide 20 described above, as compared with in a case where a light guide plate in the form of a single plate is used, it is possible to reduce material cost. This too helps achieve cost reduction. With a light guide plate in the form of a single plate, the mold for fabricating it needs to be changed to suit varying display areas of the liquid crystal display panel 60; by contrast, with the light guide 20 (light guide unit UT), the mold for fabricating it need not be changed and, simply by changing the number of light guides 20 (light guide units UT), it is possible to cope with varying display areas of the liquid crystal display device 80. Thus, by use of the light guide 20 (light guide unit UT), it is possible to reduce the cost of fabricating the mold etc., and to cope with different models.

In the first embodiment, by building the direct-lit backlight unit 50 by use of the light guide 20 described above, since a direct-lit backlight unit helps reduce loss of incident light compared with a edge-lit backlight unit, it is possible to obtain a high-efficiency backlight unit 50.

In the first embodiment, owing to the light receiving portion 21 of the light guide 20 being formed by use of part of the spheroid 5, the light introduced into the light receiving portion 21 can easily be totally reflected, and this helps suppress leakage of light effectively. That is, the light from the LED 15 can be guided into the wall portions 22 at opposite sides without letting it escape upward or sideways. Thus, it is possible to alleviate luminance unevenness immediately over the LED 15, and thus to obtain high-quality planar light easily.

By configuring the spheroid 5 to have its rotation axis a inclined with respect to the ceiling wall 22U of the wall portion 22 (with respect to the extension direction (X direction) of the wall portion 22) (by forming the reflective surface 21a of the light receiving portion 21 by use of part of the surface of a spheroid with an inclined rotation axis a), the light introduced into the light receiving portion 21 can more easily be totally reflected, and thus it is possible to suppress leakage of light more effectively.

In the first embodiment, the light receiving portion 21 of the light guide 20 is given the shape of a plurality of (two) spheroids 5 coupled together, and is so structured that a focal point F11 of one spheroid 5a coincides with a focal point F21 of the other spheroid 5b. Thus, when the light receiving point of the light receiving portion 21 overlaps the one focal point F11 (F21) included in the parts of the plurality of spheroids 5 where these overlap each other, light is more likely to pass by the other focal point of the spheroids 5. Thus, with this structure, it is easier to reflect light toward the wall portion 22.

In the first embodiment, owing to the light source unit 30 described above being arranged immediately behind the diffuser plate 43, by controlling the lighting of the LEDs 15 in the light source unit 30 individually, it is possible to perform area-by-area lighting control (local control of light amount) such as local dimming control. In addition, by varying the number of light source units 30, it is possible to vary the maximum value of the amount of light that the backlight unit 50 can emit.

As described above, in the first embodiment, by building the direct-lit backlight unit 50 with the light source unit 30 having the light guide 20 (light guide unit UT), it is possible to realize a low-cost, high-efficiency, and slim backlight unit 50. Moreover, by use of this backlight unit 50, it is possible to realize at low cost a liquid crystal display device 80 capable of area-by-area lighting control such as local dimming control.

### Embodiment 2

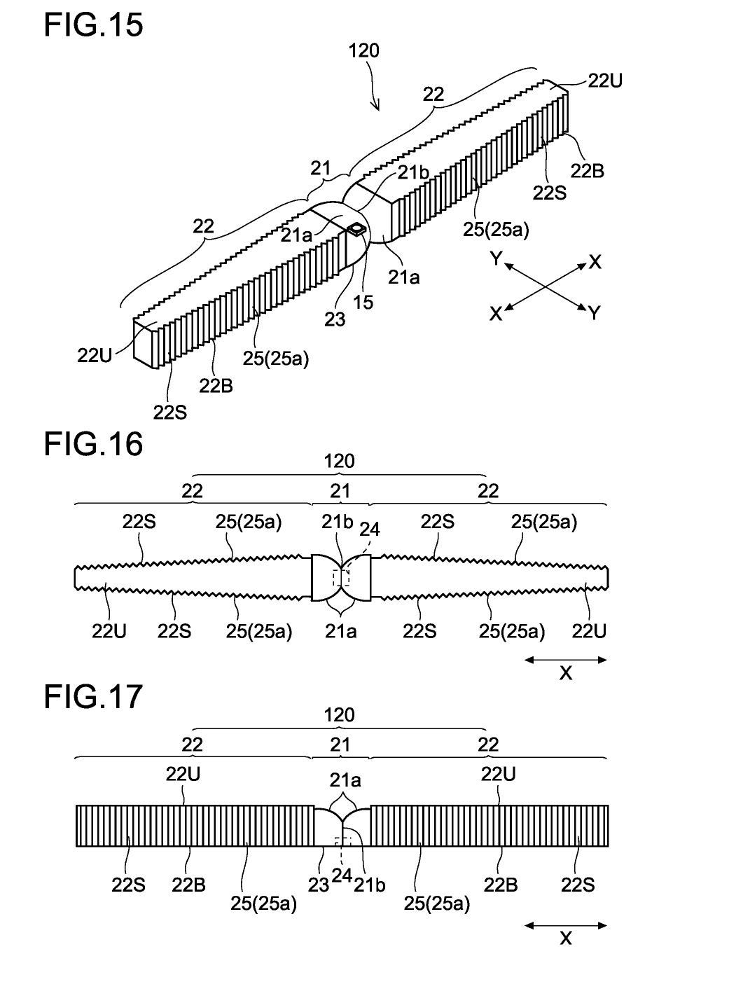

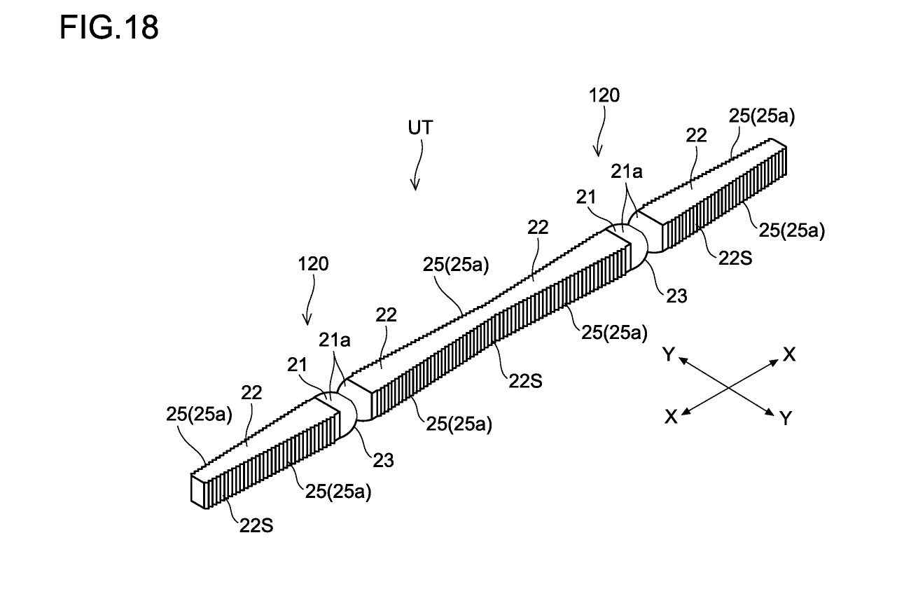

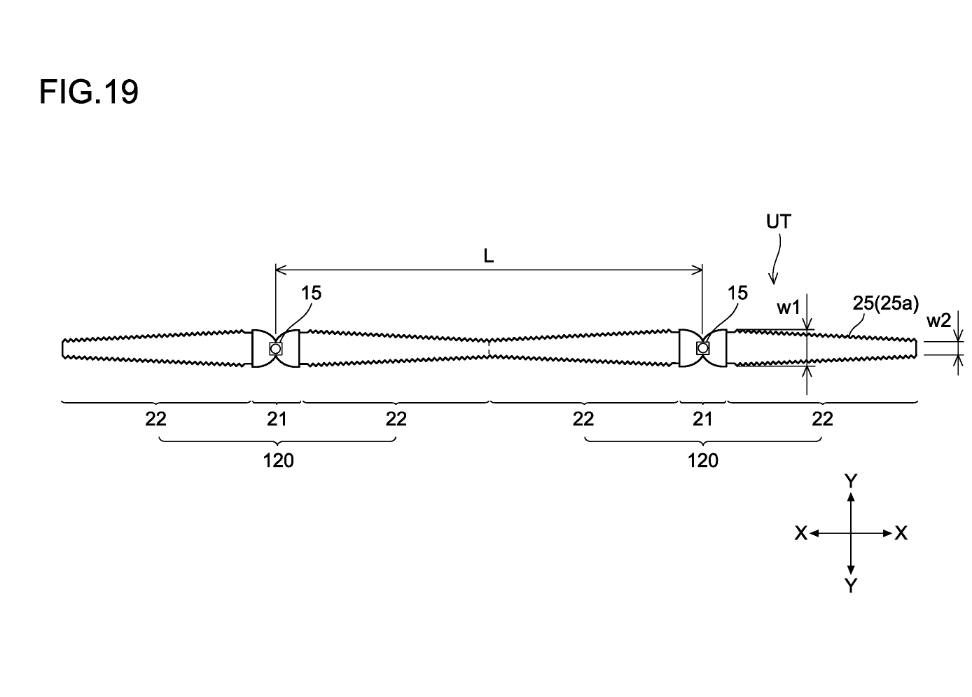

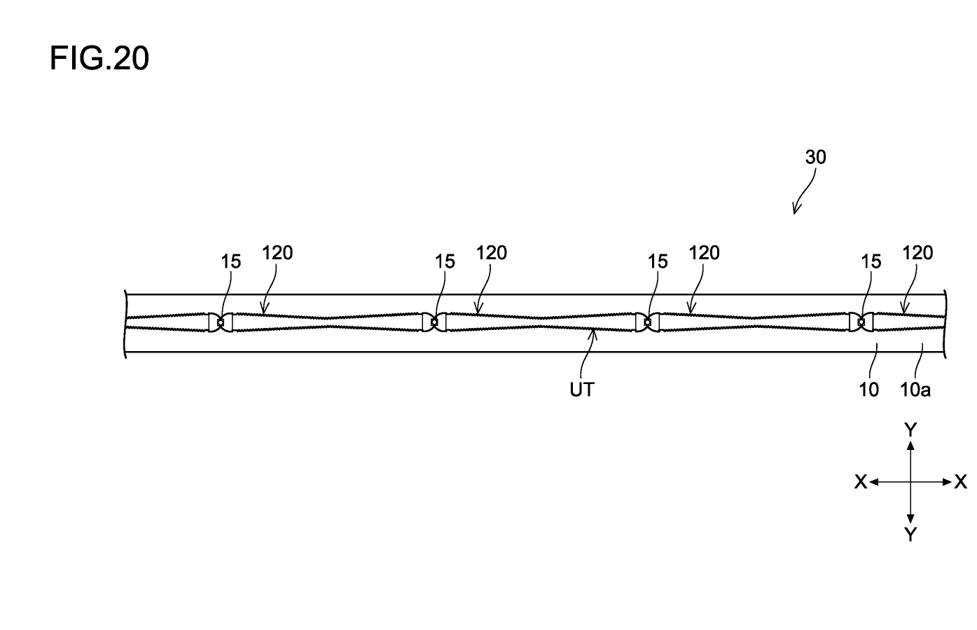

FIGS. 15 to 17 are diagrams showing a light guide according to a second embodiment of the invention. FIGS. 18 and 19 are diagrams showing a light guide unit having light guides according to the second embodiment of the invention put together end-on-end. FIG. 20 is a plan view of a light source unit employing light guides according to the second embodiment of the invention. Next, with reference to FIGS. 15 to 20, the light guide, the light guide unit, and the light source unit according to the second embodiment of the invention will be described. Among different diagrams, corresponding parts are identified by common reference signs, and no overlapping description will be repeated.

In the light guide 120 according to the second embodiment, as shown in FIGS. 15 and 16, the wall portion 22 is given a shape that tapers off the farther away from the light receiving portion 21. Specifically, the wall portion 22 of the light guide 120 is so formed that its width (width in the Y direction) is greatest at its one end where the light receiving portion 21 is provided and decreases gradually the farther away from the light receiving portion 21. The width of the wall portion 22 is smallest at its other end farthest from the light receiving portion 21.

As shown in FIG. 17, the height of the wall portion 22 is constant over its entire length. The wall portion 22 has, at its one end where the light receiving portion 21 is provided, for example, a width w1 (see FIG. 19) of about 4.5 mm and, at its other end farthest from the light receiving portion 21, for example, a width w2 (see FIG. 19) of about 2 mm.

In the second embodiment, on the side wall 22S of the wall portion 22, a coarse surface 25 is formed which is, for example, a prismed surface like the one in the first embodiment described previously. The coarse surface 25 here, however, unlike in the first embodiment described previously, is so structured that triangular prisms so long as to reach from the floor wall 22B to the ceiling wall 22U are formed almost over the entire area of the side wall 22S. With this structure, it is easy for the light inside the light guide 120 to exit outside through the side wall 22S of the wall portion 22.

As shown in FIGS. 18 and 19, a plurality of light guides 120 as described above are arrayed in one direction and are put together end-on-end to form a light guide unit UT. As in the first embodiment, a plurality of such light guide units UT are arranged side by side.

In the second embodiment also, the plurality of light guides 120 are coupled together in such a way that ends of adjacent wall portions 22 face each other. Here, the light guide unit UT may be composed of a plurality of light guides 120 coupled integrally together, or may be composed of a plurality of light guides 20 arrayed discretely.

As shown in FIG. 20, the light guides 120 (the light guide unit UT) structured as described above are fitted on a mounting board 10 having LEDs 15 mounted on it, so as to form a light source unit 30. In the second embodiment also, the interval between the LEDs 15 in the light source unit 30 (light guide unit UT) is, for example, about 54.5 mm.

By use of the light source unit 30 described above, a direct-lit backlight unit is built.

In other respects, the structure according to the second embodiment is similar to that according to the first embodiment described previously.

In the second embodiment, as described above, owing to the wall portion 22 of the light guide 120 being given a tapered shape, it is possible to suppress leakage of light from the tip-end part of the light guide 120. Thus, when a plurality of such light guides 120 are arrayed in one direction and are put together end-on-end to form a light guide unit UT, between adjacent light guides 120, it is possible to suppress light traveling from one light guide 120 to the other. Thus, it is possible to suppress luminance unevenness resulting from light traveling from one light guide 120 to the other. It is thus possible to obtain high-quality planar light.

By building a backlight unit by use of the light source unit 30 etc. according to the second embodiment, it is possible to easily realize a low-cost, high-efficiency, and slim backlight unit.

In other respects, the benefits according to the second embodiment are similar to those according to the first embodiment described previously.

### Embodiment 3

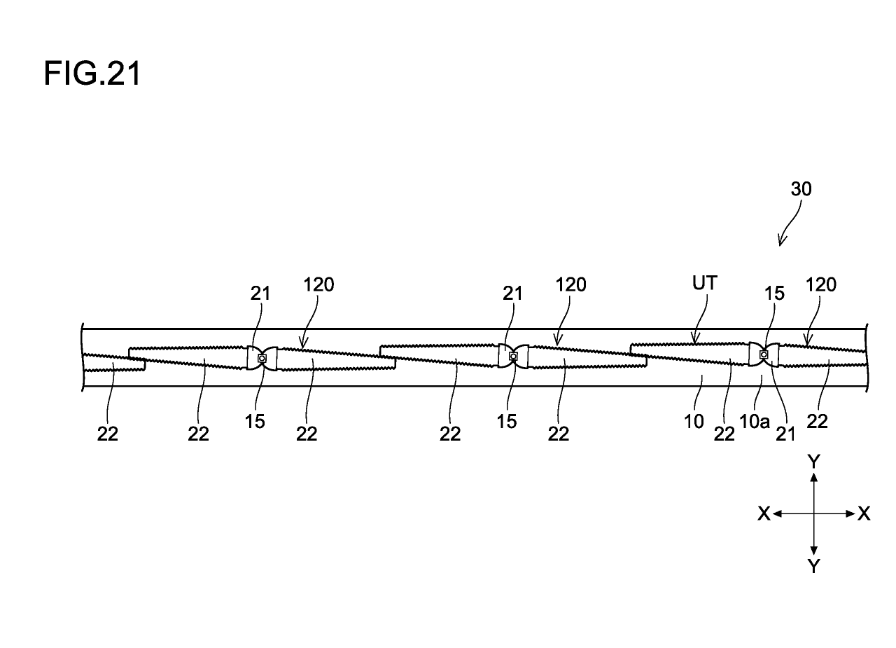

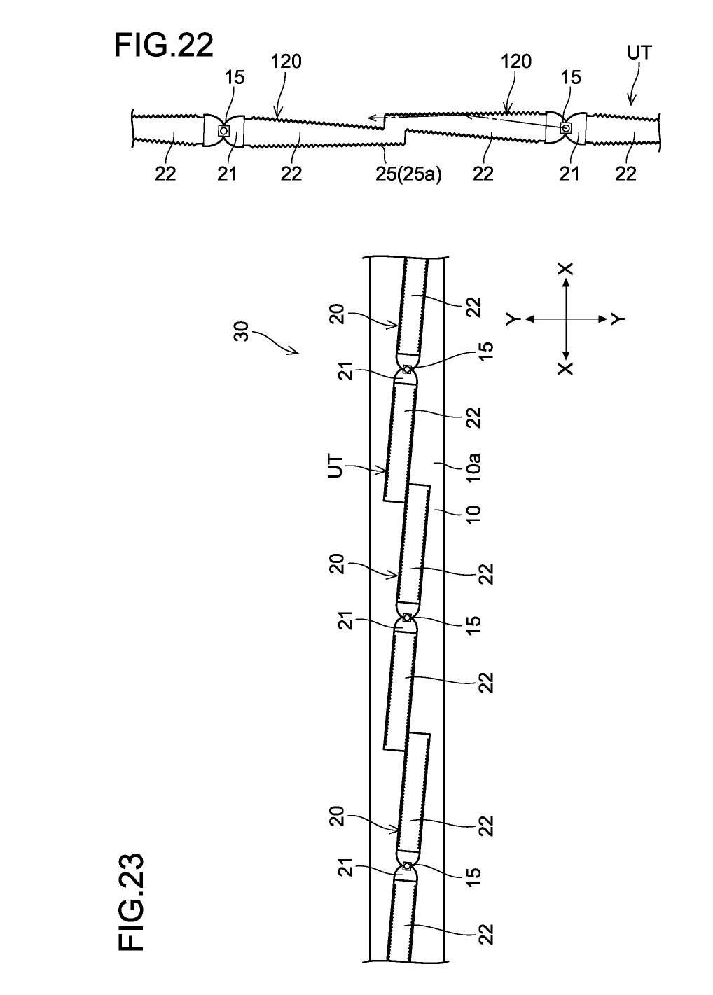

FIGS. 21 and 22 are plan views showing a light source unit according to a third embodiment of the invention. Next, with reference to FIGS. 21 and 22, a light guide and a light source unit according to the third embodiment of the invention will be described. Among different diagrams, corresponding parts are identified by common reference signs, and no overlapping description will be repeated.

In the light source unit according to the third embodiment, as shown in FIG. 21, a plurality of light guides 120 according to the second embodiment described previously are arrayed with each of them slanted and are put together end-on-end. The plurality of light guides 120 thus arrayed in one direction and put together end-on-end form a light guide unit UT.

More specifically, whereas in the second embodiment described previously, the plurality of light guides 120 are coupled together in such a way that ends of adjacent wall portions 22 face each other, in the third embodiment, the light guides 120 are arranged with each of them slanted so that the plurality of light guides 120 are coupled together in such a way that ends of adjacent wall portions 22 do not face each other.

The light guide unit UT may be composed of a plurality of light guides 120 arrayed discretely, or may be composed of, as shown in FIG. 22, a plurality of light guides 120 coupled integrally together.

In the third embodiment, as described above, on the mounting board 10, a plurality of light guides 120 are arrayed with each of them slanted and are put together end-on-end so that, even when light exits from a tip-end part (end) of the wall portion 22 as indicated by dash-and-dot-line arrows in FIG. 22, it is possible to suppress light traveling into the wall portion 22 of the neighboring light guide 120. Thus, when a plurality of light guides 120 are coupled together, it is possible to suppress the inconvenience of light from a neighboring LED 15 being guided into the light guide 120 and exiting from the light receiving portion 21. Thus, it is possible to suppress luminance unevenness resulting from light from a neighboring LED 15 exiting from the light receiving portion 21.

In the second embodiment described previously, the wall portion 22 of the light guide 120 is given a tapered shape, and this suppresses leakage of light from a tip-end part of the light guide 120 (wall portion 22). Even with this structure, light may leak from a tip-end part (end) of the wall portion 22. To prevent that, in a case where a plurality of light guides 120 are arrayed in one direction and are put together end-on-end, it is preferable that, as in the third embodiment, the plurality of light guides 120 be arranged in such a way that ends of adjacent wall portions 22 do not face each other. With this structure, it is possible to more effectively suppress light being guided into the wall portion 22 of a neighboring light guide 120.

By building a backlight unit by use of the light source unit 30 according to the third embodiment, it is possible to realize a low-cost, high-efficiency, and slim backlight unit with further suppressed luminance unevenness.

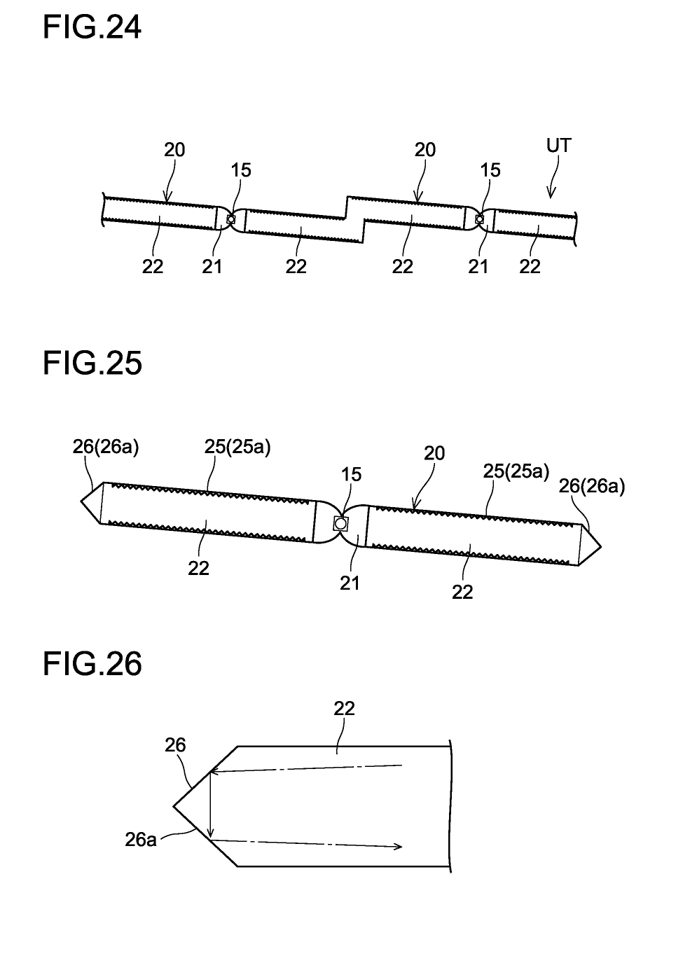

FIGS. 23 and 24 are plan views showing a light source unit according to a modified example of the third embodiment. FIGS. 25 and 26 are diagrams showing an example where the light source unit according to the modified example of the third embodiment is provided with a retroreflective structure. Next, with reference to FIGS. 23 to 26, the light source unit according to the modified example of the third embodiment will be described. Among different diagrams, corresponding parts are identified by common reference signs, and no overlapping description will be repeated.

In the modified example of the third embodiment, as shown in FIG. 23, a plurality of light guides 20 according to the first embodiment described previously are arrayed with each of them slanted and are put together end-on-end. The plurality of light guides 20 thus arrayed in one direction and put together end-on-end form a light guide unit UT. That is, in the modified example of the third embodiment, instead of the light guide 120 according to the second embodiment, the light guide 20 according to the first embodiment is employed, and this is the difference from the third embodiment described above.

The light guide unit UT may be composed of a plurality of light guides 20 arrayed discretely, or may be composed of, as shown in FIG. 24, a plurality of light guides 20 coupled integrally together.

Here, in the modified example of the third embodiment, unlike in the third embodiment described above, the wall portion 22 of the light guide 20 is not tapered, and thus light tends to exit from a tip-end part of the wall portion 22. To prevent that, it is preferable that, as shown in FIG. 25, a retroreflective structure 26 be provided in a tip-end part of the wall portion 22. Specifically, it is preferable that a retroreflective projection 26a in the shape of a quadrangular pyramid be provided in a tip-end part of the wall portion 22. When a retroreflective projection 26a in the shape of a quadrangular pyramid is provided in a tip-end part of the wall portion 22 in this way, the light introduced into the wall portion 22 is, as indicated by dash-and-dot-line arrows in FIG. 26, reflected in the direction from which it is incident. Thus, it is possible to reduce the light leaking from the light guide 20 (the tip-end part of the wall portion 22). Thus, by building a backlight unit by use of such a light guide 20 (light source unit 30), it is possible to further reduce luminance unevenness.

The retroreflective structure 26 may instead be provided in a tip-end part of the light guide 120 according to the third embodiment.

### Embodiment 4

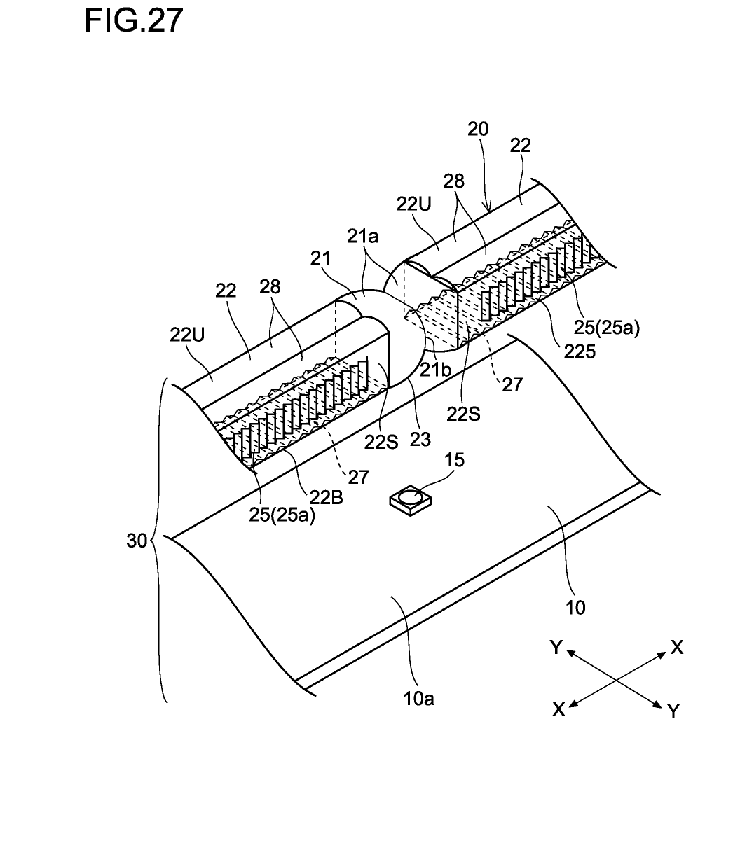

FIGS. 27 to 29 are diagrams showing a light source unit according to a fourth embodiment of the invention. Next, with reference to FIGS. 27 to 29, a light guide and a light source unit according to the fourth embodiment of the invention will be described. Among different diagrams, corresponding parts are identified by common reference signs, and no overlapping description will be repeated.

In the fourth embodiment, as shown in FIG. 27, as compared with the structure according to the first embodiment described previously, on the floor wall 22B of the wall portion 22 of the light guide 20, a deflecting processed surface 27 is further formed which guides light so as to deflect it upward. Moreover, on the ceiling wall 22U of the wall portion 22 of the light guide 20, a lens 28 is further formed which diffuses light.

The deflecting processed surface 27 is, for example, a processed surface formed by arranging on the floor wall 22B triangular prisms extending in one direction (linearly) side by side in the extension direction of the wall portion 22 (in the same direction as the X direction). The lens 28 formed on the ceiling wall 22U has, for example, the shape of two cylindrical curved surface arranged side by side.

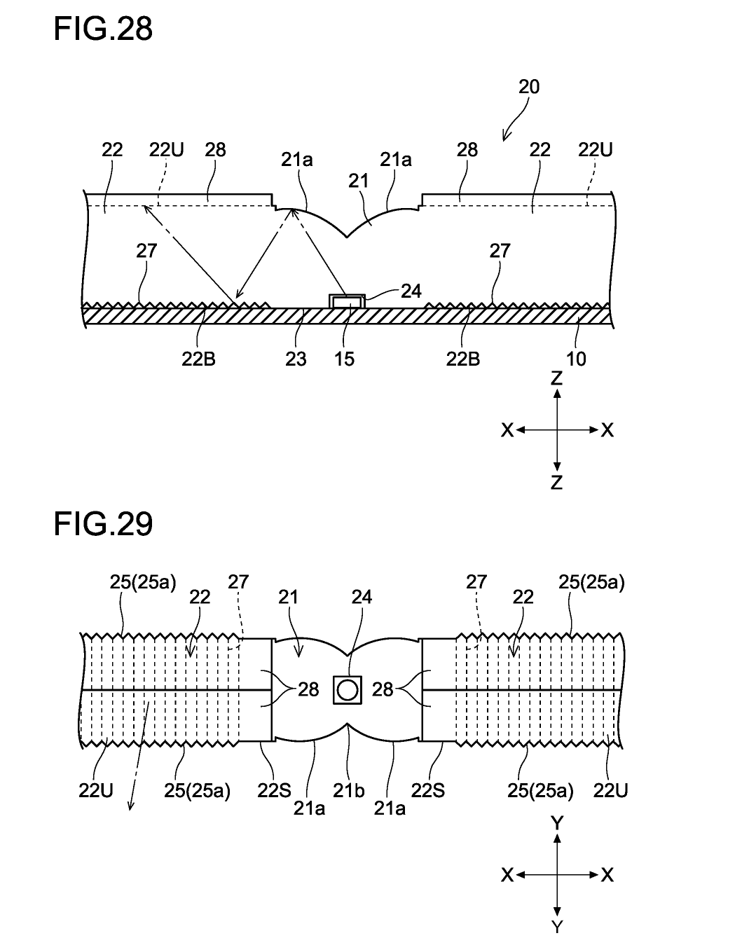

With the light guide 20 described above, for example, as shown in FIG. 28, even when light totally reflected on the reflective surface 21a of the light receiving portion 21 reaches the floor wall 22B of the wall portion 22, the light is guided, as indicated by dash-and-dot-line arrows, toward the ceiling wall 22U by the deflecting processed surface 27 on the floor wall 22B. When this light reaches the ceiling wall 22U, it is then refracted in different directions by the lens 28 on the ceiling wall 22U. Consequently, as indicated by a dash-and-dot-line arrow in FIG. 29, the light from the light guide 20 is radiated about the light guide 20 as the center.

Although, in the fourth embodiment, an example is taken where the deflecting processed surface 27 and the lens 28 are formed on the light guide 20 according to the first embodiment, it is also possible to form the deflecting processed surface 27 and the lens 28 on the light guide 120 according to the second embodiment.

### Embodiment 5

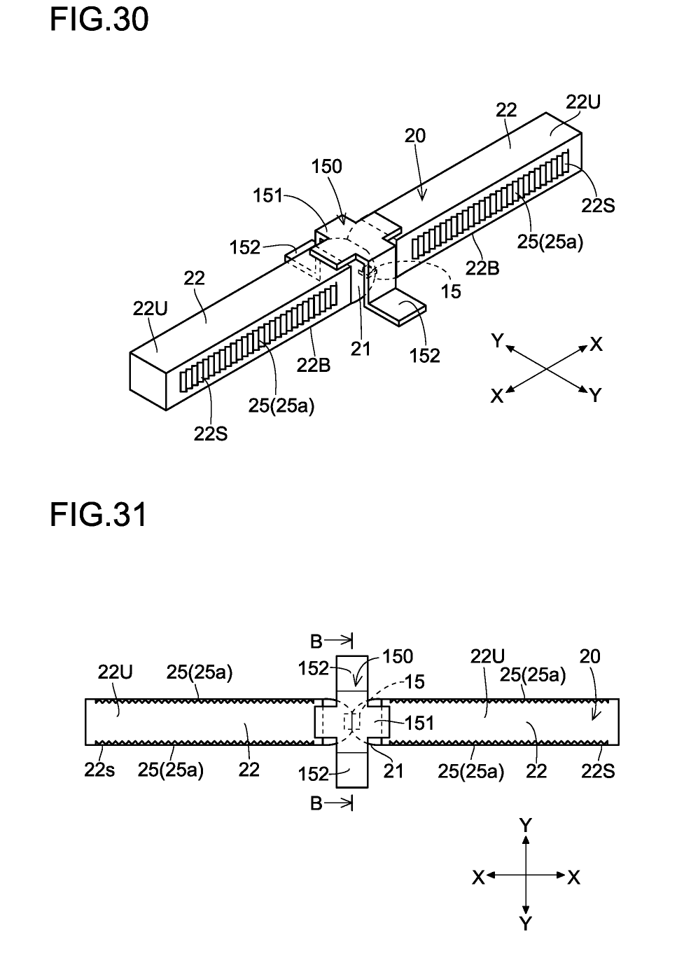

FIGS. 30 to 34 are diagrams in illustration of a backlight unit according to a fifth embodiment of the invention. Next, with reference to FIGS. 30 to 34, the backlight unit according to the fifth embodiment will be described. Among different diagrams, corresponding parts are identified by common reference signs, and no overlapping description will be repeated.

In the fifth embodiment, by use of, for example, the light source unit according to the first embodiment described previously, a backlight unit is built. Moreover, as shown in FIGS. 30 and 31, the light guide 20 provided in the light source is fixed with a fixing member 150.

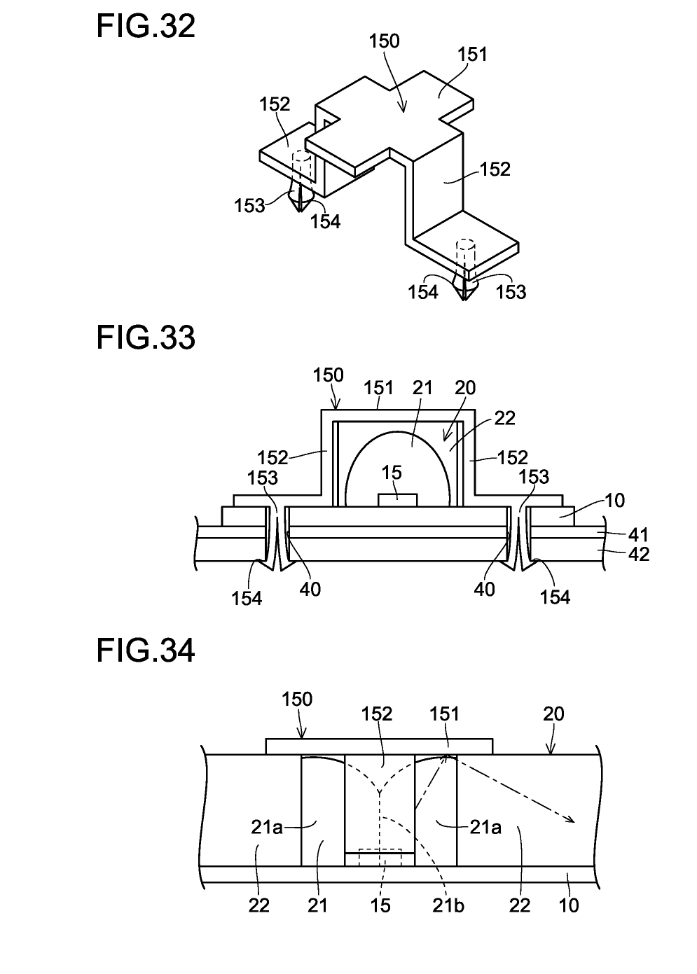

The fixing member 150 is formed of a material with sufficient reflectance, for example a white resin or a metal material. As shown in FIG. 32, the fixing member 150 is provided with a pressing portion 151, which makes contact with the light guide 20 so that the pressing portion 151, at its part in contact with the light guide 20, presses this, and a leg portion 152, which is contiguous with the pressing portion 151. The leg portion 152 of the fixing member 150 is provided with a pin-shaped engagement piece 153. As shown in FIG. 33, the engagement piece 153 is, for example, bifurcated and its tip-end part is formed into a hook-shaped engagement portion 154. As shown in FIG. 31, the pressing portion 151 of the fixing member 150 is, for example, in the shape of a cross as seen in a plan view; thus, the pressing portion 151 covers the light receiving portion 21, and in addition part of the pressing portion 151 makes contact with part of the ceiling wall 22U of the wall portion 22.

On the other hand, in the mounting board 10, the reflective sheet 41, and the backlight chassis 42, a continuous through hole 40 is formed for putting the engagement piece 153 of the fixing member 150 through.

As shown in FIGS. 30 and 33, the fixing member 150 structured as described above is placed so as to lie over the light receiving portion 21 of the light guide 20, with the engagement piece 153 put through the through hole 40 in the part of the backlight chassis 42. The engagement portion 154 of the engagement piece 153 engages with the rim of the through hole 40, so that the fixing member 150 keeps the light guide 20 in fixed position. Here, the light receiving portion 21 of the light guide 20 is in a state covered by the fixing member 150.

When the light guide 20 is fixed by use of the fixing member 150 described above, even if, as shown in FIG. 34, a displacement or the like of the LED 15 causes light to leak from the light receiving portion 21, the leaking light can be shielded with the fixing member 150 covering the light receiving portion 21. This helps suppress luminance unevenness more effectively.

By use of the fixing member 150 described above, the light guide 20 can be fixed more easily than when it is fixed by use of adhesive or the like.

By forming the fixing member 150 out of a material with high reflectance such as a white resin or a metal material, when light leaks from the light receiving portion 21, as indicated by dash-and-dot-line arrows in FIG. 34, the leaking light can be reflected on the fixing member 150 so as to be easily guided to the wall portion 22 of the light guide 20.

Although, in the fifth embodiment, an example is taken where the light source unit according to the first embodiment described previously is used, a similar effect can be obtained by use of a light source unit other than according to the first embodiment (for example, the light source units according to the second to fourth embodiments). That is, the light guide 120 according to the second embodiment may be fixed with the fixing member.

### Embodiment 6

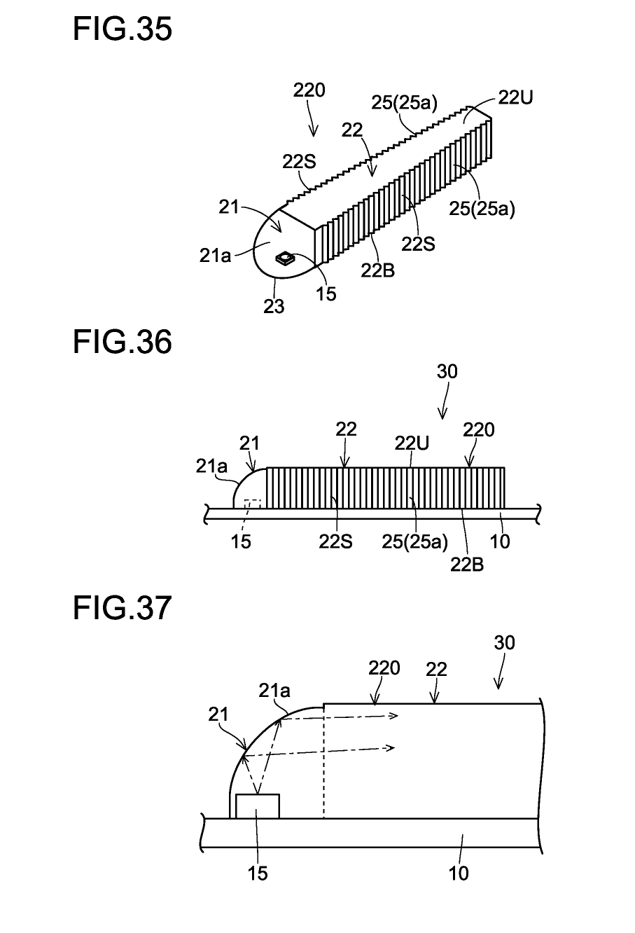

FIGS. 35 to 37 are diagrams in illustration of a light source unit according to a sixth embodiment of the invention. Next, with reference to FIGS. 7 and 35 to 37, the light source unit according to the sixth embodiment of the invention will be described. Among different diagrams, corresponding parts are identified by common reference signs, and no overlapping description will be repeated.

As shown in FIGS. 35 and 36, the light guide 220 according to the sixth embodiment is provided with one wall portion 22 and one light receiving portion 21. That is, in the sixth embodiment, the light receiving portion 21 of the light guide 220 is so configured as to guide the light from the LED 15 in one direction.

Specifically, the wall portion 22 of the light guide 220 is formed like the wall portion 22 in the second embodiment described previously, and the light receiving portion 21 of the light guide 220 has a shape using one spheroid 5 (see FIG. 7).

It is preferable that the reflective surface of the light receiving portion 21 be given a shape using a spheroid 5 as described above, and it is further preferable that it be given a shape that can totally reflect as much as possible of the light that is radiated upward from the LED 15.

In a case where the light guide 220 described above is used, as shown in FIG. 37, the light radiated upward from the LED 15 can be, as indicated by dash-and-dot-line arrows, reflected on the reflective surface 21a of the light receiving portion 21 to be guided toward the wall portion 22. On the side wall 22S of the wall portion 22, a coarse surface 25 such as a prismed surface is formed, and thus the light path of the light guided into the wall portion 22 is changed by the coarse surface 25 to one suitable for outward emission, so as to be radiated sideways.

### Embodiment 7

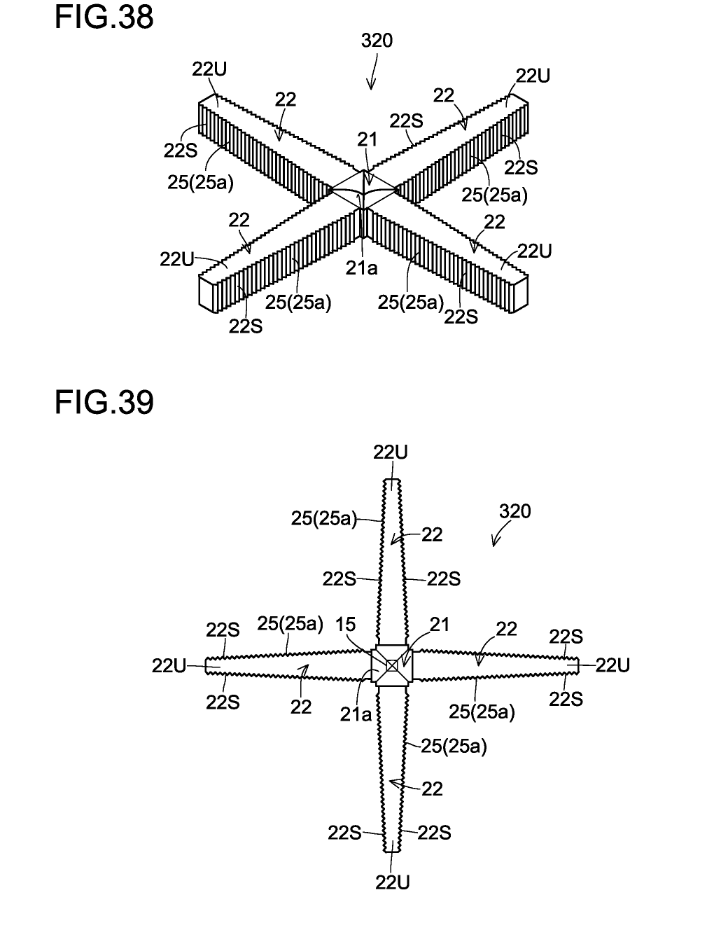

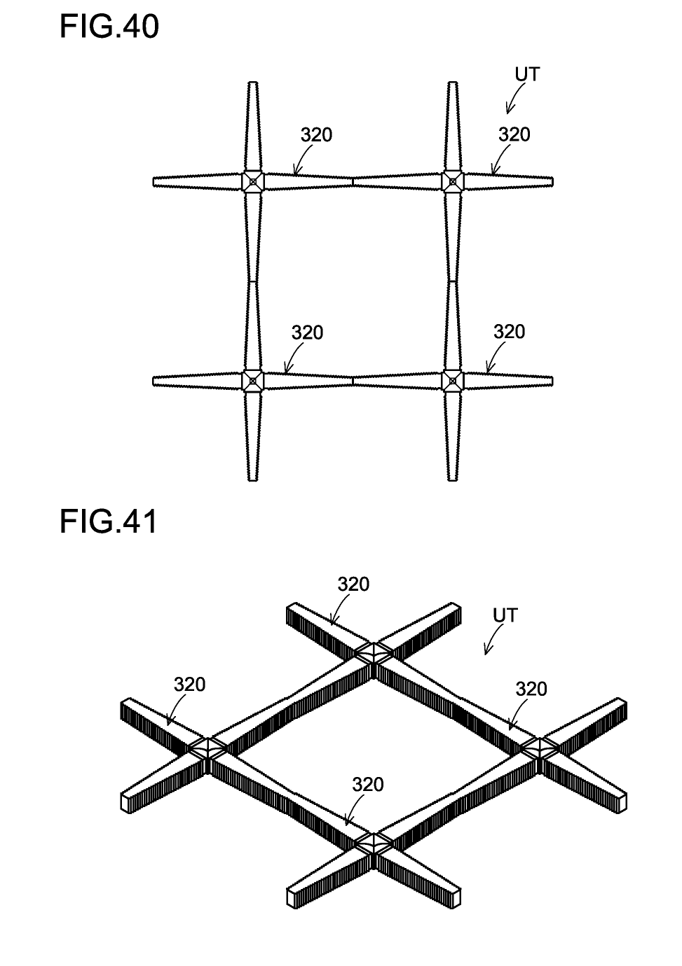

FIGS. 38 and 39 are diagrams showing light guides according to a seventh embodiment of the invention. FIGS. 40 and 41 are diagrams showing a light guide unit having light guides according to the seventh embodiment of the invention put together end-on-end. Next, with reference to FIGS. 1, 7, 8, 15, and 38 to 41, the light guide and the light guide unit according to the seventh embodiment of the invention will be described. Among different diagrams, corresponding parts are identified by common reference signs, and no overlapping description will be repeated.

In the first to sixth embodiments described previously, the light guide is provided with two or one bar-shaped wall portion 22; the light guide may instead have more than two wall portions 22. For example, according to the seventh embodiment, the light guide 320 is provided with four bar-shaped wall portions 22. Specifically, as shown in FIGS. 38 and 39, in the seventh embodiment, four wall portions 22 extend radially from a light receiving portion 21 as the center. More specifically, two of the light guides 120 (see FIG. 15) according to the second embodiment described previously are combined together into the shape of a cross as seen in a plan view.

The light receiving portion 21 of the light guide 320 has a structure in which four spheroids 5 (see FIGS. 7 and 8) corresponding to the four wall portions 22 are combined together (coupled together). As in the first and second embodiments described previously, it is preferable that one focal point of each of the plurality of (four) spheroids coincides with one focal point of every other.

As shown in FIGS. 40 and 41, the light guide unit UT according to the seventh embodiment is built by putting together a plurality of light guides 320 as described above end-on-end into a lattice shape.

FIGS. 40 and 41 show an example where the putting together is done in such a way that end surfaces of the wall portions 22 face each other; instead, as in the third embodiment described previously, the plurality of the light guides 320 may be arrayed with each of them slanted and put together end-on-end in such a way that the end faces of the wall portions 22 do not face each other.

In the seventh embodiment, the wall portion 22 of the light guide 320 is given a shape similar to that of the wall portion 22 of the light guide 120 according to the second embodiment described previously; instead, it may be given a shape similar to that of the wall portion 22 of the light guide 20 (see FIG. 1) according to the first embodiment described previously.

### Embodiment 8

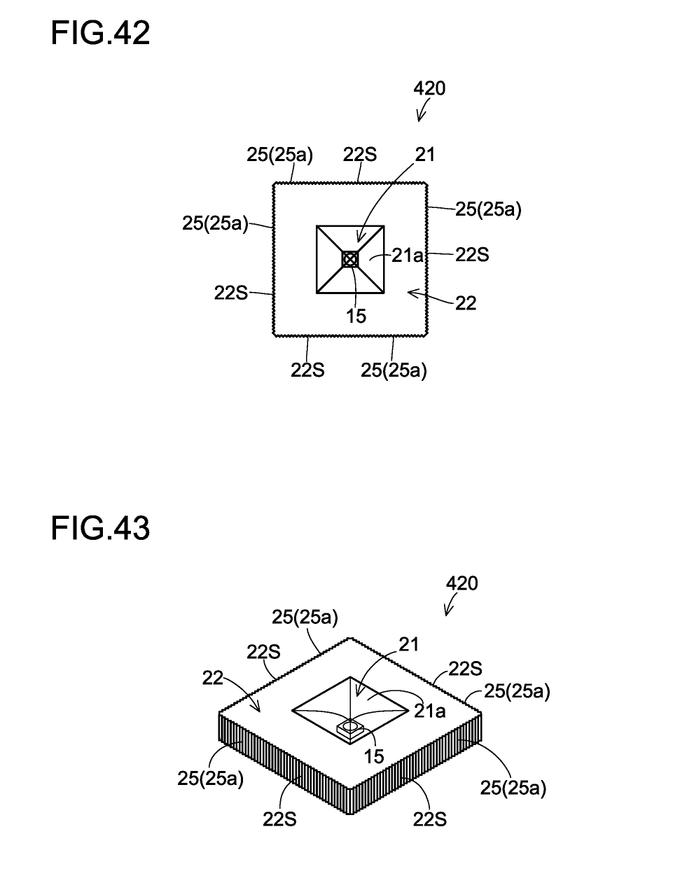

FIGS. 42 and 43 are diagrams showing a light guide according to an eighth embodiment of the invention. Next, with reference to FIGS. 42 and 43, the light guide according to the eighth embodiment of the invention will be described. Among different diagrams, corresponding parts are identified by common reference signs, and no overlapping description will be repeated.

In the eighth embodiment, as shown in FIGS. 42 and 43, unlike in the first to seventh embodiments described previously, the wall portion 22 of the light guide 420 is formed in the shape of a block (chip) extending in all directions around the light receiving portion 21.

Specifically, as shown in FIG. 42, the wall portion 22 of the light guide 420 is formed in a rectangular shape as seen in a plan view, with the light receiving portion 21 provided in its central part. The light receiving portion 21 may have, for example, as in the seventh embodiment described previously, a structure where four spheroids are coupled together.

In the eighth embodiment, even with no coarse surface 25 provided on the side wall 22S of the wall portion 22, light can be emitted from the side wall 22S, but for purposes like that of diffusing light, a coarse surface 25 may be provided on the side wall 22S of the wall portion 22. Needless to say, no coarse surface 25 may be provided on the side wall 22S of the wall portion 22.

Even with this configuration, the light radiated upward from the LED 15 is reflected on the light receiving portion 21 to be guided toward the wall portion 22, and is then emitted outside through the side wall 22S of the wall portion 22. That is, also by use of this light guide 420, the light radiated upward from the LED 15 can be spread sideways.

The embodiments presented herein are to be considered in every respect merely illustrative and not restrictive. The scope of the present invention is defined not by the description of embodiments given above but by the appended claims, and encompasses any variations and modifications in the sense and scope equivalent to those of the claims.

For example, although the first to eighth embodiments presented above deal with examples where the light receiving portion of the light guide is given a shape using a spheroid, this is not meant to limit the invention; it may instead be given any other shape than specifically mentioned above so long as it can guide the light radiated upward from the LED toward the wall portion. However, as mentioned in connection with the embodiments described above, forming the light receiving portion by use of a spheroid makes it easy to totally reflect the light from the LED in the light receiving portion, and this makes it possible, while suppressing leakage of light from the light receiving portion, to easily guide the light from the LED toward the wall portion. For this reason, it is preferable that the light receiving portion of the light guide be formed by use of a spheroid. In this case, the shape and inclination (the inclination angle of the rotation axis) of the spheroid may be set as necessary.

Although the first to eighth embodiments presented above deal with examples where a coarse surface such as a prismed surface is formed on the side wall of the wall portion, the angle of the prism of the prismed surface, the formation position of the coarse surface, etc. may be changed as necessary. For example, although the first embodiment presented above deals with an example where the prismed surface (coarse surface) is provided in a substantially central part of the wall portion in its thickness direction, it may instead be provided on the floor wall side of the wall portion in its thickness direction (in a region close to the reflective sheet). In that case, the distance from the prismed surface (coarse surface) to the diffuser plate is long, and this effectively suppresses luminance unevenness.

Although the first to eighth embodiments presented above deal with examples where a coarse surface such as a prismed surface is formed on the side wall of the wall portion, this is not meant to limit the invention; a coarse surface other than a prismed surface may instead be provided on the side wall of the wall portion. For example, instead of a prismed surface, a coarse surface such as crimped surface or a dot-printed surface may be formed on the side wall of the wall portion. Or a coarse surface which is a combination of such surfaces may be formed on the side wall of the wall portion. Any other coarse surface than mentioned above may be formed on the side wall of the wall portion so long as it is a coarse surface that changes the light path of the light inside to one suitable for outward emission.

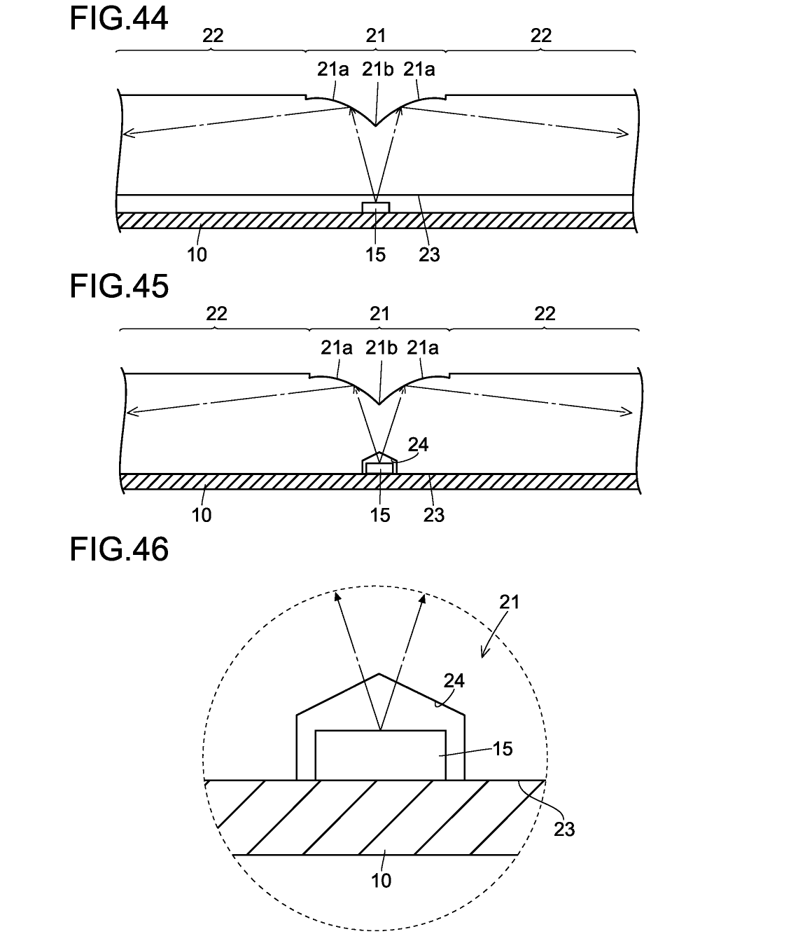

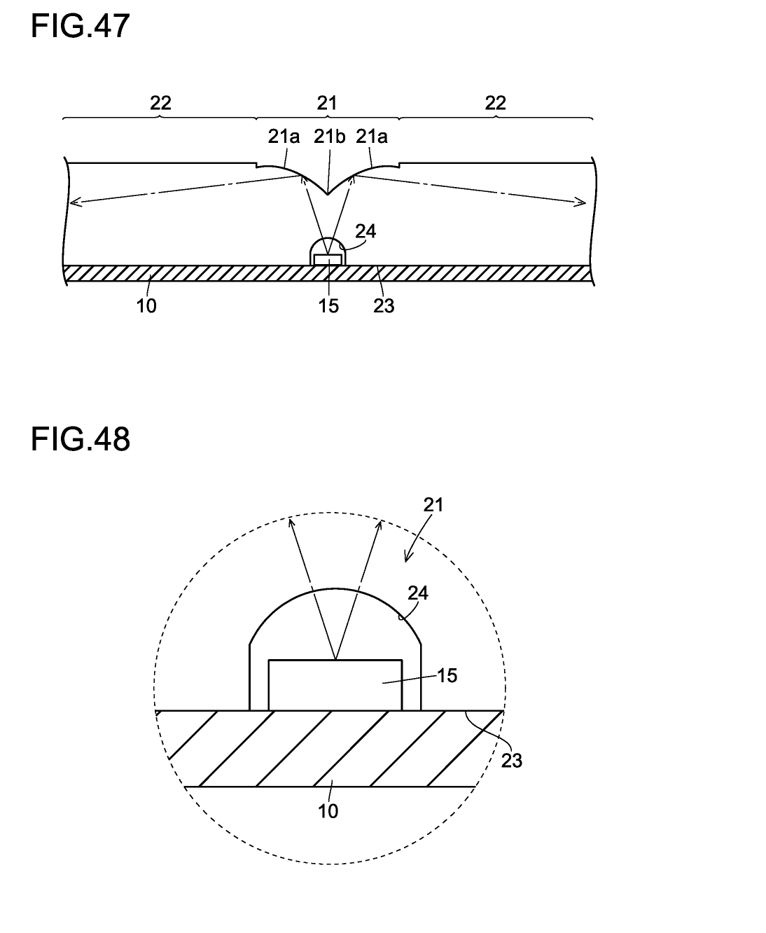

Although the first to eighth embodiments presented above deal with examples where a recess is formed in the floor surface of the light receiving portion, this is not meant to limit the invention; for example as shown in FIG. 44, no recess may be formed in the floor surface 23 of the light receiving portion 21. Specifically, the floor surface 23 of the light receiving portion 21 in the light guide may be flat so that the light from the LED 15 travels toward that flat surface. In a case where no recess is formed in the floor surface 23 of the light receiving portion 21, the floor surface 23 of the light receiving portion 21 serves as the light receiving surface. In a case where a recess is formed in the floor surface of the light receiving portion, the recess may be, as shown in FIGS. 45 and 46, formed in a shape that tapers off from the floor surface 23 inward. That is, the recess 24 may be formed to include a conic part. The recess 24 may be formed, as shown in FIGS. 47 and 48, so as to include a hemispherical part.

In the first to eighth embodiments presented above, the dimensions, shapes, etc. of the light guide may be changed as necessary. In a case where the light guide includes a plurality of wall portions, these wall portions may be formed in similar shapes etc., or in different shapes etc.

In the embodiments presented above, there is no particular restriction on the type of the LED. For example, the LED may be one that includes an LED chip (light emitting chip) emitting blue light and a phosphor (fluorescent or phosphorescent substance) giving off yellow fluorescence on receiving the light from the LED chip. This type of LED produces white light from the light of the blue light emitting LED chip and the light of the fluorescence. There is no restriction on the number of LED chips included in the LED.

The phosphor included in the LED is not limited to one that gives off yellow fluorescence. For example, the LED may be one that includes an LED chip emitting blue light and a phosphor giving off green and red fluorescence on receiving the light from the LED chip and that produces white light from the blue light of the LED chip and the light (green and red light) of the fluorescence.

The LED chip included in the LED is not limited to one that emits blue light. For example, the LED may include a red LED chip emitting red light, a blue LED chip emitting blue light, and a phosphor giving off green fluorescence on receiving the light from the blue LED chip. This type of LED produces white light from the red light of the red LED chip, the blue light of the blur LED chip, and the green light of the fluorescence.

The LED may include no phosphor. For example, the LED may include a red LED chip emitting red light, a green LED chip emitting green light, and a blue emitting chip emitting blue light so as to produce white light by mixing the light from all those LED chips.

The light emitted from individual light guides is not limited to white light, and may instead be red, green, or blue light. It is, however, preferable that light guides emitting red, green, and blue light be arranged as close together as possible so that the light from them mixes to produce white light. For example, it is preferable that a light guide emitting red light, a light guide emitting green light, and a light guide emitting blue light be arranged next to one another.

Although the first to eighth embodiments presented above deal with examples where the backlight unit includes, as optical members (optical sheets), a diffuser plate, a prism sheet, and a lens sheet, this is not meant to limit the invention; these optical members (optical sheets) may be changed (added or omitted) as necessary.

The number of light guides (light guide units, light source units) included in the backlight unit may be changed as necessary to suit the kind of the backlight unit etc.

Although the first to eighth embodiments presented above deal with examples where the present invention is applied to a liquid crystal display device as one example of a display device, this is not meant to limit the invention; the present invention may be applied to non-luminous display devices in general which are provided with a backlight unit for supplying a display panel with light.

Although the first to seventh embodiments presented above deal with examples where a light source unit is built by use of a light guide unit composed of a plurality of light guides put together end-on-end, this is not meant to limit the invention; the light source unit may be built by use of discrete light guides without forming a light guide unit. The mounting board may be given any other shape than in the embodiments described above.

Although the first to sixth embodiments presented above deal with examples where the light guide (light guide unit, light source unit) is arranged so as to extend along the longer-side direction (X direction) of the backlight unit, this is not meant to limit the invention; the light guide (light guide unit, light source unit) may instead be arranged so as to extend along the shorter-side direction (Y direction) of the backlight unit. The light guide (light guide unit, light source unit) may be arranged in a direction crossing the longer-side direction (X direction) of the backlight unit. Individual light guides (light guide units, light source units) may be arranged in different directions.

The third embodiment presented above deals with an example where the tip-end part of the wall portion of the light guide is formed in the shape of a quadrangular pyramid, this is not meant to limit the invention; it may instead be formed in the shape of a triangular pyramid or a prism. In a tip-end part of the wall portion, a projection or a plurality of projections having the shape described above may be formed. It is preferable that the tip-end part of the wall portion having the shape described above be so formed that the angle of its vertex equals 90 degrees.

Although the fourth embodiment presented above deals with an example where a deflecting processed surface having triangular prisms is formed on the floor wall of the wall portion and a lens having two cylindrical curved surfaces arranged side by side is formed on the ceiling wall of the wall portion, this is not meant to limit the invention; the deflecting processed surface may be any processed surface other than a triangular prism surface (for example, a crimped surface or a dot-printed surface), and the lens may have any different lens shape.

In the fifth embodiment presented above, the fixing member which keeps the light guide in fixed position may have any other shape than specifically described above. It is, however, preferable that the fixing member be one that can keep the light guide in fixed position while covering its light receiving portion, because then the light leaking from the light receiving portion can be shielded.

Although the seventh embodiment presented above deals with an example of a light guide having four wall portions, this is not meant to limit the invention; the light guide may have three, or five or more, wall portions.

Although the eighth embodiment presented above deals with an example where the light guide (wall portion) is formed in a rectangular shape as seen in a plan view, this is not meant to limit the invention; the wall portion of the light guide may instead be given, for example, a triangular shape, a polygonal shape with five or more corners, or a circular shape.

The present invention encompasses in its technical scope any embodiments obtained by appropriately combining together different technical features described above.

### LIST OF REFERENCE SIGNS

5, 5a, 5b spheroid
10 mounting board
15 LED (light source)
20, 120, 220, 320, 420 light guide
21 light receiving portion
21a reflective surface
21b constriction line
22 wall portion
22S side wall
22U ceiling wall
22T end surface
22B floor wall
23 floor surface
24 recess
25 coarse surface (light path changing processed surface)
25a prismed surface (light path changing processed surface)
26 retroreflective structure
26a projection
27 deflecting processed surface
28 lens
30 light source unit
41 reflective sheet
42 backlight chassis
43 diffuser plate
44 prism sheet
45 lens sheet
50 backlight unit (illuminating device)
60 liquid crystal display panel (display panel)
61 active matrix substrate
62 counter substrate
63 polarizer film
70 housing
71 front housing member
72 rear housing member
80 liquid crystal display device (display device)
150 fixing member
151 pressing portion
152 leg portion
153 engagement piece
154 engagement portion

1. A light guide for guiding received light inside, comprising:
a light receiving portion for receiving light; and
a wall portion contiguous with the light receiving portion, wherein
the light receiving portion has a light receiving surface at a floor surface side thereof and includes a reflective surface in a shape of a curved surface for reflecting light toward the wall portion, and
the wall portion includes a side wall having a light path changing processed surface for changing a light path of light inside to a light path suitable for outward emission.

2. The light guide according to claim 1, wherein
the light receiving portion has a shape using part of a spheroid.

3. The light guide according to claim 2, wherein
a rotation axis of the spheroid is inclined with respect to a ceiling wall of the wall portion.

4. The light guide according to claim 2, wherein
the light receiving portion has a shape of a plurality of spheroids coupled together, and
one focal point of each of the plurality of spheroids coincides with one focal point of every other of the plurality of spheroids.

5. The light guide according to claim 4, wherein
the light receiving portion has a shape of two spheroids coupled together, and
one focal point of one of the spheroids coincides with one focal point of the other of the spheroids.

6. The light guide according to claim 1, wherein
a deflecting processed surface for deflecting light upward is formed on a floor surface of the wall portion, and
a lens for diffusing the light is formed on a ceiling wall of the wall portion.

7. The light guide according to claim 1, wherein
the wall portion is formed in a shape of a bar, and
the light receiving portion is formed at an end of the wall portion formed in a shape of a bar.

8. The light guide according to claim 7, wherein
the light receiving portion is disposed between two of the wall portion each formed in a shape of a bar, and
the received light is guided in two directions by the reflective surface in the light receiving portion.

9. The light guide according to claim 7, wherein
a retroreflective structure for reflecting incident light in a direction from which the light is incident is formed in a tip-end part of the wall portion.

10. The light guide according to claim 9, wherein
the retroreflective structure includes a projection having a shape of a quadrangular pyramid.

11. The light guide according to claim 7, wherein
the wall portion in a shape of a bar has a shape that tapers off the farther away from the light receiving portion.

12. The light guide according to claim 1, wherein
the light path changing processed surface includes a prismed surface, a crimped surface, or a dot-printed surface.

13. The light guide according to claim 1, wherein
the light receiving portion has a recess caved in from a floor surface thereof, and
the recess is a part of the light receiving portion where the light receiving portion receives light.

14. A light source unit comprising:
the light guide according to claim 1; and
a light source for supplying the light guide with light.

15. The light source unit according to claim 14, wherein
the wall portion of the light guide is formed in a shape of a bar, and
a plurality of the light guide are arrayed with each of them slanted and are put together end-on-end.

16. The light source unit according to claim 14, wherein
the light source is a light emitting device, and
the light receiving portion of the light guide is arranged over the light emitting device.

17. An illuminating device comprising the light source unit according to claim 14.

18. The illuminating device according to claim 17, further comprising a fixing member for fixing the light guide, wherein
the fixing member covers at least part of the light receiving portion, and
the fixing member is formed of a white resin.

19. (canceled)

20. The illuminating device according to claim 17, further comprising a diffuser plate for diffusing light from the light guide, wherein
the diffuser plate is arranged over the light source and the light guide.

21. A display device comprising:
an illuminating device according to claim 17; and
a display panel receiving light from the illuminating device.
